(19) United States
(12) Patent Application Publication
(10) Pub. No.: US 2014/0082659 A1
(43) Pub. Date: Mar. 20, 2014

(54) SYSTEMS AND METHODS FOR GENERATING PROGRESSIVE ADVERTISEMENT SCHEDULES IN MEDIA ASSETS

(71) Applicant: UNITED VIDEO PROPERTIES, INC., Santa Clara, CA (US)

(72) Inventors: Brian Fife, Concord, MA (US); Michael Nichols, La Canada, CA (US)

(73) Assignee: UNITED VIDEO PROPERTIES, INC., Santa Clara, CA (US)

(21) Appl. No.: 13/622,542

(22) Filed: Sep. 19, 2012

(51) Int. Cl. H04N 21/81

(52) U.S. Cl. CPC H04N 21/812
USPC 725/32

(57) ABSTRACT

Methods and systems for generating progressive advertisement schedules in media assets. Advertisement schedules are generated for currently displayed media assets based at least in part on the advertisement schedules associated with media assets previously viewed by the user and the number of advertisements presented to a user while the user viewed the previous media asset.

### BACKGROUND OF THE INVENTION

In conventional systems, advertisements or commercials presented to users provide the funding means for a variety of media assets. Television broadcasts, streaming internet media, and even some on-demand programs are supported by commercials or advertisements shown during their play lengths. To prevent users from becoming irritated, or from losing interest in the program, commercials are typically displayed only during commercial breaks. Each commercial break typically shows several advertisement and lasts for a few minutes.

The length and point of insertion of commercial breaks is often a delicate balancing act for the content provider. For example, if a content provider provides all the advertisements after the media assets, the provider risks that the user will change channels or select a new media asset before viewing the advertisements. Likewise, if a content provider provides all the advertisements before the media asset, the provider risks that the user will lose interest and stop viewing the remaining advertisements and the media asset.

In an effort to prevent users from changing channels or switching to other media assets, conventional systems often distribute the advertisement intervals or commercial breaks throughout the play length of the media asset. Typically, the advertisements are provided in blocks at regular intervals. For example, in broadcast television, commercial breaks typically occur at the fifteen and thirty minute marks of a thirty minute program. Likewise, media assets streamed over the internet to users also use periodic advertisement intervals.

Current scheduling systems allow users viewing broadcast television to game the system by changing a channel showing a commercial to a channel not showing a commercial, avoiding all commercials. In addition, if a user switches from one streaming media asset to another after viewing a “pre-roll” advertisement, the viewer will be forced to see another pre-roll advertisement regardless of the amount of time the user viewed the first media asset. The repetition of advertisements, and in some cases the same advertisement, can be frustrating to the user, increasing the likelihood that this viewer will stop viewing the advertisements and media assets entirely.

### SUMMARY OF INVENTION

Accordingly, methods and systems are disclosed herein for generating progressive advertisement schedules in media assets. Advertisement schedules are generated for currently displayed media assets based at least in part on the advertisement schedules associated with media assets previously viewed by the user, and the number of advertisements displayed to a user while the user viewed the previous media asset.

In some embodiments, an advertisement scheduling application determines a default advertisement schedule for advertisements to be displayed during the play length of a first media asset. Upon receiving a user input requesting access of a second media asset during the play length of the first media asset, the advertisement scheduling application determines a second advertisement schedule for the second media asset based at least in part on the number of advertisements displayed while the user accessed the first media asset. The advertisement scheduling application may be applied to both broadcast and on-demand systems. Moreover, the advertisement scheduling application may be implemented on local and/or remote equipment, and the local and/or remote equipment may be used to transmit, receive, and/or process advertisement schedules and data related to advertisement schedules.

For example, metadata indicating an advertisement schedule associated with a first media asset may be transmitted to an advertisement scheduling application along with the request of the user to view a second media asset. The advertisement scheduling application may then compute an advertisement schedule based on not only the default advertisement schedule of the second media, but also the advertisement schedule of the first media asset. Therefore, the user experiences a more balanced overall advertisement schedule, while the user views the multiple media assets.

In another example, in a streaming or an on-demand media system a user may be watching a first media asset. The first media asset may have a first advertisement schedule (e.g., a pre-roll advertisement followed by two minute advertisement intervals at the ten and twenty-five minute marks in the play length of the first media asset). After the pre-roll advertisement, the user decides to change to a second media asset after two minutes of the first media asset. The second media asset has a default second advertisement schedule (e.g., a pre-roll advertisement followed by two minute advertisement intervals at the ten and twenty-five minute marks in the play length of the second media asset).

Processing the metadata associated with the advertisement schedule of the first media asset received with the user's new selection, the advertisement scheduling application generates a progressive second advertisement schedule (e.g., no pre-roll advertisement followed by a three minute advertisement intervals at the ten minute and twenty-five minute marks in the play length of the second media asset). In doing so, the advertisement scheduling application compensates the user for the pre-roll advertisement viewed during the advertisement schedule of the first media asset, but also compensates the media content provider for the time the user watched the first media asset by increasing the length of the advertisement intervals in the progressive advertisement schedule from two minutes to three minutes.

In some embodiments, the advertisement scheduling application may transmit a first media asset to user equipment and determine a schedule of advertisements for a first media asset. Upon receiving user input to transmit a second media asset before the end of the first media asset, the advertisement scheduling application transmits a second media asset to the user equipment, and determines a second advertisement schedule for the second media asset.

The second schedule of advertisements is progressive and incorporates aspects of the advertisement schedule of the first media asset. In some embodiments, the second, progressive, advertisement schedule is based at least in part on a default advertisement schedule for the second media asset. In some embodiments, the number of advertisement intervals, and the number of advertisements in each interval, of the second schedule is based at least in part on the number of advertisements displayed to the user while the user was viewing the first media asset.

In some embodiments, the number of advertisement intervals and the location of each advertisement interval in the second media asset may be based at least in part on the number of first advertisements displayed during the portion of the first play length. In some embodiments, the advertisement scheduling application may allocate a particular number of advertisements to the first media asset. Based on the allocation, and, more particularly, whether the allocation was consistent with the number of advertisements viewed by the user while the user viewed the first media, the advertisement scheduling application may adjust the number of advertisement intervals, and advertisements in each interval, shown to the user while the user views the second media asset.

In some embodiments, the advertisement scheduling application adjusts the second advertisement schedule (e.g., the advertisement intervals and the advertisements in each interval) based on a quality associated with advertisements viewed by the user while the user viewed the first media asset. In some embodiments, the first media asset may be displayed on a first device and the second media asset may be displayed on a second device. In some embodiments, the first media asset may be broadcast from a content provider, and the second media asset may be streamed from a content provider. In some embodiments, the second advertisement schedule may be partially based on a user profile associated with the user or a play length associated with the second media asset.

It should be noted, the systems and/or methods described above may be applied to, or used in accordance with, other systems and/or methods.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative diagram displaying the advertisement scheduling application creating a progressive advertisement schedule in accordance with some embodiments of the disclosure;

FIG. 2 shows an illustrative diagram displaying the advertisement scheduling application creating a progressive advertisement schedule across multiple platforms in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps involved in using an advertisement scheduling application to create a progressive advertisement schedule in accordance with some embodiments of the disclosure;

FIG. 6A is a diagram of an illustrative media system displaying the advertisement scheduling source facilitating a progressive advertisement schedule in a broadcast system in accordance with some embodiments of the disclosure;

FIG. 6B is a diagram of an illustrative media system displaying the advertisement scheduling source facilitating a progressive advertisement schedule in an on-demand or streaming media system in accordance with some embodiments of the disclosure;

FIG. 6C is a diagram of an illustrative media system displaying the advertisement scheduling source facilitating a progressive advertisement schedule in a media system with multiple platforms in accordance with some embodiments of the disclosure;

FIG. 7 shows an exemplary data structure for a transmission file associated with a media asset in accordance with some embodiments of the disclosure;

FIG. 8 shows an exemplary data structure for a compilation of data associated with a user profile in accordance with some embodiments of the disclosure;

FIG. 9 is a flowchart of illustrative steps involved for generating a progressive advertisement schedule based on a user profile in accordance with some embodiments of the disclosure;

FIG. 10 is a flowchart of illustrative steps involved for determining a progressive advertisement schedule based on multiple advertisement schedules in accordance with some embodiments of the disclosure;

FIG. 11 is a flowchart of illustrative steps involved for determining a progressive advertisement schedule based on the quality and quantity of advertisements in an advertisement schedule in accordance with some embodiments of the disclosure;

FIG. 12 is a flowchart of illustrative steps involved for determining a progressive advertisement schedule based on multiple advertisement schedules and advertisements already presented to a user in accordance with some embodiments of the disclosure;

FIG. 13A shows an illustrative diagram displaying the advertisement scheduling application creating a progressive advertisement schedule in accordance with some embodiments of the disclosure;

FIG. 13B shows an illustrative diagram displaying the advertisement scheduling application creating a progressive advertisement schedule in accordance with some embodiments of the disclosure; and

FIG. 13C shows an illustrative diagram displaying the advertisement scheduling application creating a progressive advertisement schedule in accordance with some embodiments of the disclosure.

### DETAILED DESCRIPTION

The methods and systems described herein are for generating progressive advertisement schedules in media assets. Advertisement schedules may define the number of advertisements presenting during a media asset, the number of advertisement intervals during a media asset, the length of advertisements presenting during a media asset, the length of advertisement intervals during a media asset, the length between advertisement intervals, the particular advertisements shown during a media asset or advertisement interval, the particular type of advertisements shown during a media asset or advertisement interval, or any other attribute or characteristic of advertisements shown during one or more media assets.

An advertisement interval is segment of time in which advertisements are shown. For example, commercial breaks during broadcast television programs or streaming media assets may be advertisement intervals. Advertisement intervals may include one or more advertisements. The advertisements within an interval may be related or unrelated. The length of advertisement intervals may be the same or different during a media asset. Moreover, the length of advertisement intervals in one or more media assets may be the same or different.

As used herein, a “progressive advertisement schedule” refers to an advertisement schedule, that is based on the advertisement schedules of multiple media assets accessed by a user. In some embodiments, the multiple media assets may be related. In some embodiments, the multiple media assets may be unrelated. In some embodiments, a progressive advertisement schedule may be generated by an advertisement scheduling application. As used herein, an “advertisement scheduling application” is an application that schedules advertisements to be displayed during media assets. In some embodiments, the advertisement scheduling application may generate a progressive schedule across multiple devices (e.g., a set-top box and a table computer used by the same person), or across multiple content delivery systems (e.g., from a broadcast television program to a streaming media asset on a website).

In some embodiments, the advertisement scheduling application may be located at, and issue instructions from, a remote server (e.g., a content source or cloud-based source) or a local user device (e.g., a smartphone). Progressive advertisement schedules may be generated based at least in part on one or more default advertisement schedules. As used herein, a “default advertisement schedule” refers to an advertisement schedule associated with a media asset that may be altered, or replaced, when generating a progressive advertisement schedule. The default advertisement schedule may be a predetermined advertisement schedule generated by a content provider or other source.

In some embodiments, a progressive advertisement schedule may be generated based at least in part on another progressive advertisement schedule. For example, in some embodiments, a user may currently be receiving advertisements based on a progressive advertisement schedule, after selecting a new media asset, a new progressive advertisement schedule may be generated based at least in part on the previous progressive advertisement schedule.

In some embodiments, a progressive advertisement schedule may be based at least in part on a user profile. User profiles, as used herein, are compilations of information about a user. A profile may relate to a user, or a group of users, and include information relating to actions taken by a user while viewing media assets, either in the current viewing session or in a previous viewing session. For example, a user profile may indicate the number of advertisements, or the length of an advertisement (or advertisements), that the user will view before stopping the presentation of the media asset or ending their viewing session.

A user profile may also relate to user equipment or devices associated with a particular user. For example, a user profile may indicate one or more set-top boxes, smartphones, or tablet computers associated with the user. It should be noted that throughout this disclosure, reference to a progressive advertisement schedule in regards to a user could also be applied to a group of user using one or more devices.

A user profile may also relate to preferences, actions, or decisions related to the performance, distribution, recommendation, creation or consumption (including purchasing) of media assets. For example, a user profile may include media content interests such as a user's favorites, likes, dislikes, ratings, critical reviews, or recommendations in regards to a media asset, shows or series currently being watched, shows or series likely to be watched, the time a user typically watches a show or series, or the genre of the show or series typically watched by the user. For example, the advertisement scheduling application may use information in a user profile to estimate the length of time a user may watch a particular media asset.

Furthermore, a user profile may include demographic information related to a user such as traits regarding the user that are indicative of a user's actions. For example, a user profile may contain the age, gender, income level, marital status, race and/or ethnicity of the user as any of these traits may suggest a particular media content interest of a user or the user's viewing patterns (e.g., the typical time the user will watch media assets in one sitting). In addition, the profile may include user viewing histories, market research relating to the user, industry reports relating to the user, surveys, and/or interviews that may suggest a possible viewing pattern or interest of the user. For example, an industry report may suggest that because the user is a particular age, the user is likely to enjoy a particular group of shows and watch the shows for a particular amount of time.

In some embodiments, the advertisement scheduling application may also generate a progressive advertisement schedule based at least in part on user inputs or actions. For example, a user input, or data in a user profile, may indicate that the user prefers to view an extended advertisement, fill out an online questionnaire, or take another type of action, which may alter the progressive advertisement schedule. For example, a user may indicate (e.g., via a user input) that instead of viewing advertisements at regular intervals during media assets, the user prefers to watch an extended initial advertisement and then access thirty minutes of advertisement-free media assets. Upon completion of the extended initial advertisement, the advertisement scheduling application will remove any advertisement intervals during any media assets viewed by the user for the allotted amount of time (e.g., thirty minutes).

In some embodiments, a viewing session may refer to the substantially uninterrupted access by a user to one or more media assets. For example, a viewing session may include the continuous view of multiple media assets and advertisements without disrupting the continuity of the presentation of any of the media assets or advertisements. In some embodiments, a viewing session may include only minimal breaks in continuity (e.g., pausing the presentation of the media asset to answer a phone or use the bathroom). In some embodiments, a viewing session may be measured in minutes, hours, or any other measurement of time. In some embodiments, a viewing session may include accessing multiple media assets on multiple devices, either in parallel or in series.

In some embodiments, progressive advertisement schedules may be generated for currently displayed media assets based at least in part on the advertisement schedules associated with media assets previously viewed by the user, and the number of advertisements displayed to a user while the user viewed the previous media asset. For example, progressive advertisement schedules may be generated based on the length of time that a user watched one or more previous media assets or the length of time of the viewing session.

The advertisement scheduling application may receive data (e.g., metadata) indicating the advertisement schedule associated with a first media asset along with a user's request to view a second media asset. For example, upon input of a channel change request or the selection of a new media asset, the content source or user equipment may send the data to the advertisement scheduling application indicating how long the user watched the previous media asset.

In some embodiments, the advertisement scheduling application may process data associated with the media assets and the actions of a user to generate a progressive advertisement schedule. Alternatively, or in addition, in some embodiments, the advertisement scheduling application may monitor the actions of the user on user equipment and generate data. The data may then be transmitted to an advertisement scheduling source, which returns a progressive advertisement schedule to the advertisement scheduling application or user equipment. In some embodiments, the advertisement scheduling source may further coordinate, retrieve, and/or process information from a content source (e.g., the source of the media asset or assets) to provide a progressive advertisement schedule. In some embodiments, the advertisement scheduling application may monitor several devices. For example, the advertisement scheduling application may retrieve information from a user's user profile indicating the particular devices associated with the user. The advertisement scheduling application may then use the retrieved information to determine whether or not a user had previously accessed a media asset on any other device.

The advertisement scheduling application may compute a progressive advertisement schedule based on the information regarding the advertisement schedule of a first media asset as well as information regarding the advertisement schedule of a second media asset. In some embodiments, this information may be combined with information from the user's user profile. To compare/process any information the advertisement scheduling application may use multiple types of textual recognition, including fuzzy logic. For example, the particular information may be found in a data field that may be a textual data field. Using fuzzy logic, the system may determine two fields to be identical (or different) even though the substance of the data field (e.g., two different spellings) is not identical. Other suitable methods for comparing data are also contemplated by this disclosure.

The advertisement scheduling application may process this information, or transmit this information for processing (e.g., to the advertisement scheduling source), to generate a progressive advertisement schedule to replace or supplement a default advertisement schedule for one or more media assets. Therefore, the user experiences a more balanced overall advertisement schedule, while the user views the multiple media assets.

For example, in a broadcast system (e.g., broadcast television) a user may be watching a first channel. The first channel may have a default advertisement schedule (e.g., three minute advertisement intervals at the five and twenty-five minute marks in the play length of the first channel's media asset). As used herein, “play length” of a media asset or advertisement refers to the duration of time that a media asset or advertisement requires to play from its beginning to end. After ten minutes, the user decides to change to a second channel. The second channel has a default second advertisement schedule (e.g., three minute advertisement intervals at the twelve and twenty-two minute marks in the play length of the second channel's media asset). Processing the metadata associated with the default advertisement schedule of the first media asset received with the user's channel change request, the advertisement scheduling application generates a progressive second advertisement schedule (e.g., three minute advertisement interval only at the twenty-two minute mark in the play length of the second channel's media asset). In doing so, the advertisement intervals of the progressive advertisement schedule are scheduled in relation to the user's actual viewing experience, instead of the independent advertisement schedules associated with each channel.

In another example, in a streaming media system (e.g., a webcast) a user may be watching a first streaming media asset. The first streaming media asset may have a default first advertisement schedule (e.g., a pre-roll advertisement followed by two minute advertisement intervals at the ten and twenty-five minute marks in the play length of the first streaming media asset). After the pre-roll advertisement, the user decides to change to a second streaming media asset after two minutes of streaming the first media asset. The second streaming media asset has a default second advertisement schedule (e.g., a pre-roll advertisement followed by three minute advertisement intervals at the ten and twenty-five minute marks in the play length of the second streaming media asset).

Processing the metadata associated with the default first advertisement schedule received with the user's new selection, the advertisement scheduling application generates a progressive second advertisement interval schedule (e.g., no pre-roll advertisement followed by a four minute advertisement interval at the ten minute and twenty-five minute mark in the play length of the second channel's media asset). In doing so, the advertisement scheduling application compensates the user for the pre-roll advertisement viewed during the default first advertisement schedule, but also compensates the media content provider for the time the user watched the first streaming media asset by increasing the length of the advertisement interval in the progressive advertisement schedule from three minutes to four.

In some embodiments, the advertisement scheduling application may transmit a first media asset to user equipment and determine a first schedule of advertisements for a first media asset. Upon receiving user input to transmit a second media asset before the end of the first media asset, the advertisement scheduling application transmits a second media asset to user equipment and determines a second schedule of advertisements for the second media asset.

The second schedule of advertisements is progressive and incorporates aspects of the first schedule of advertisements. In some embodiments, the second, progressive, schedule of advertisements is based at least in part on a default schedule of advertisements for the second media asset. In some embodiments, the number of advertisement intervals of the second schedule is based at least in part on the number of advertisements displayed to the user while the user was viewing the first media asset.

In some embodiments, the advertisement scheduling application may allocate a particular number of advertisements to the first media asset. Based on the allocation, and, more particularly, whether the allocation was consistent with the number of advertisements viewed by the user, while the user viewed the first media, the advertisement scheduling application may adjust the number of advertisement intervals, and advertisements in each interval, shown to the user while the user views the second media asset.

In some embodiments, the advertisement scheduling application adjusts the second advertisement schedule (e.g., the advertisement intervals and the advertisements in each interval) based on the quality associated with advertisements viewed by the user while the user viewed the first media asset. In some embodiments, the advertisement scheduling application may also adjust the second advertisement schedule based on the quality associated with the second media asset or the play length of the second media asset. As used herein, the “quality” of an advertisement or media asset refers to objective criteria determined by an advertisement or content provider. For example, the quality may depend on the subject matter, the size (e.g., in bits), the format (e.g., high definition vs. standard definition), the costs and/or profits associated, and/or other objective criteria for determining high and/or low quality.

In some embodiments, the quality of the advertisement may also depend on the media asset during which the advertisement was shown, the genre of the media asset, the time-slot of the media asset, or any other objective basis. For example, the advertisement scheduling application may determine that an advertisement featuring sports apparel is of higher quality if it is shown during a sporting event than if it is shown during a different genre. Therefore, if the user views the sports apparel advertisement while accessing a sporting event, the quality that the advertisement scheduling application associates with the advertisement may change if the user subsequently accesses a second media asset of a different genre (e.g., a sitcom). In such cases, accessing a second media asset of a different genre than the first media asset may increase (or decrease) the amount or length of advertisement intervals that a user is shown compared to the amount or length of advertisement intervals that would have been shown to the user if the second media asset was of the same genre as the first media asset.

In some embodiments, the advertisement scheduling application may also adjust the number of advertisements in each interval of the second advertisement schedule depending on the order in which the intervals are displayed during presentation of the second media asset. For example, the advertisement scheduling application may schedule more advertisements, or more frequent advertisement intervals, near the beginning or the end in order to maximize the advertisements accessed by a user.

In some embodiments, advertisement or content providers may share revenue generated by the display of advertisements in the progressive advertisement schedule. For example, a revenue model may be adapted to the progressive advertisement schedule so that an advertisement or content provider receives revenue based on the amount of time a user accessed a particular media asset, irrespective of the particular advertisements viewed. In addition, other factors such as the overall audience size of one media asset to another and/or the increase or decrease of the number of users accessing the user equipment based on a channel change (or new media selection).

The advertisement scheduling application may also receive data regarding the identity of one or more users viewing a media asset from particular user equipment. For example, the advertisement scheduling application may receive user input identifying a user. In some embodiments, the advertisement scheduling application may retrieve data associated with the particular user equipment (e.g., the name of the user registered to the user equipment). In some embodiments, the advertisement scheduling application may also detect the particular user accessing the user equipment (e.g., via a sign-in or account feature).

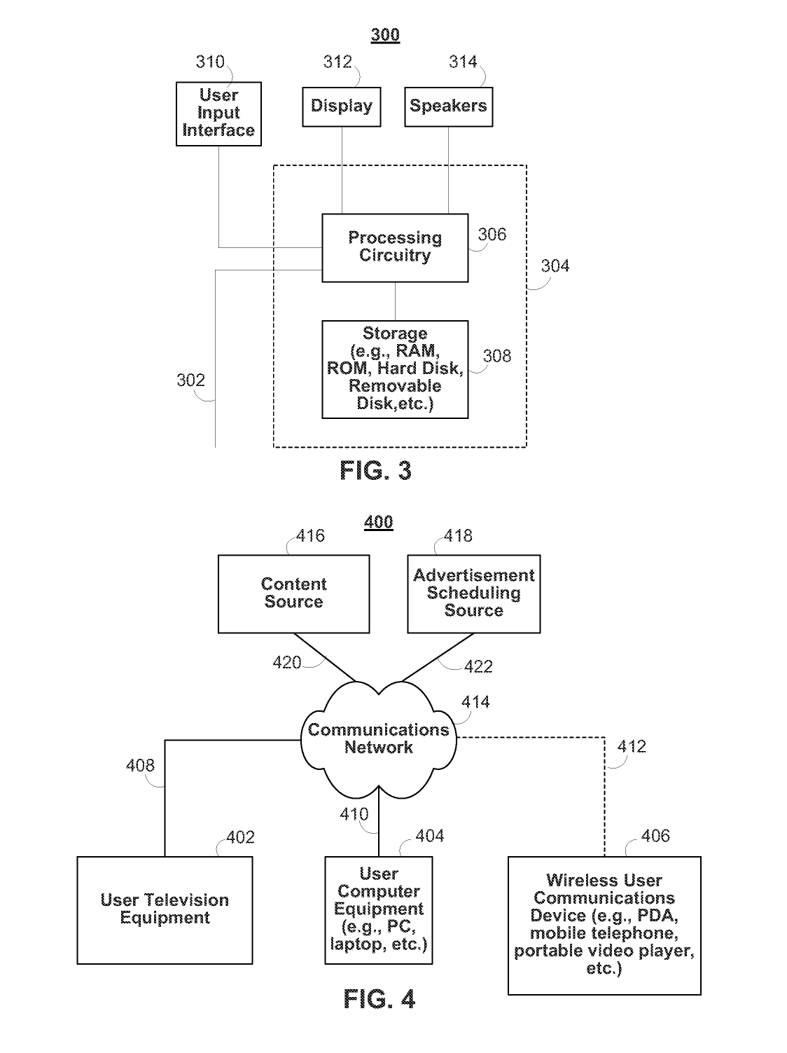

In some embodiments, intelligent detection systems may be used to input information into the advertisement scheduling application without user input. Intelligent detection systems may include, but are not limited to, user proximity detection (e.g., detecting particular users that are within viewing distance of the user equipment accessing the media asset), remote identification of users (e.g., detecting personal identifiers, such as passwords, access codes, electronic signatures, keycards, which are registered to a person), or remote identification of devices, which indicate a user is present (e.g., identifying that a smartphone registered to a particular user is within a proximity suggests that the user is within the same proximity). Furthermore, intelligent detection systems may, based on the time of day (e.g., via applications incorporating time and date information), direct the advertisement scheduling application (e.g., via control circuitry 304 (FIG. 3)) to automatically determine the particular users viewing the media asset.

In some embodiments, the advertisement scheduling application may incorporate or interact with an interactive media guidance application. Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may enable a user to navigate among, locate and select content.

As referred to herein, the terms “media asset” should be understood to mean an electronically consumable user asset, such as television programming, as well as pay-per-view programs, on-demand programs (as in video-on-demand (VOD) systems), Internet content (e.g., streaming content, downloadable content, webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance. It should also be noted that throughout this application reference to a system or method incorporating one type of content form should be understood to be adaptable to other content forms.

In some embodiments, the media asset may appear on a display screen of, or associated with, user equipment. As referred to herein, the phrase “user equipment device,” “user equipment,” “user device,” “electronic device,” “electronic equipment,” “media equipment device,” or “media device” should be understood to mean any device for accessing and/or displaying the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera used to obtain images of a user as the user accesses a media asset. Consequently, media guidance may be available on these devices, as well. The guidance provided may be for content available only through a television, for content available only through one or more of other types of user equipment devices, or for content available both through a television and one or more of the other types of user equipment devices.

In some embodiments, the media guidance application may link two devices, which act in concert to provide a single user experience. For example, in some embodiments, the media guidance application may display other users accessing the media asset on one device, while the media asset appears on another device. The media guidance applications may be provided as online applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters′ or providers′ logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or webcast, or content available on-demand as streaming content or downloadable content through an Internet website or other Internet access (e.g., FTP).

The advertisement scheduling application may provide advertisements to the user for content that, depending on a viewer's access rights (e.g., for subscription programming), is currently available for viewing, will be available for viewing in the future, or may never become available for viewing, and may correspond to, or be unrelated to, one or more media assets. Advertisements may also be for products or services related, or unrelated to, the media assets. Advertisements may be selectable and provide further information about media assets, provide information about a product or a service, enable purchasing of content, a product, or a service, provide content relating to the advertisement, etc. Advertisements may be targeted based on a user's profile/preferences, monitored user activity, the type of display provided, or on other suitable targeted advertisement bases.

Advertisements may be rectangular or banner-shaped, or advertisements may be provided in any suitable size, shape, and location. For example, advertisements may be provided as a rectangular shape that is horizontally adjacent to the display of a media asset. This is sometimes referred to as a panel advertisement. In addition, advertisements may be overlaid over media assets or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other display screens of the embodiments described herein or accompanying, adjacent to, or interspersed with related media content listings.

The advertisement scheduling application may be personalized based on a user's preferences. A personalized advertisement scheduling application allows a user to customize displays, advertisements, and other features to create a personalized “experience” with the advertisement scheduling application. This personalized experience may be created by allowing a user to input these customizations and/or by the advertisement scheduling application monitoring user activity to determine various user preferences. Users may access their personalized advertisement scheduling application by logging in or otherwise identifying themselves to the advertisement scheduling application. Customization of the advertisement scheduling application may be made in accordance with a user profile. The customizations may include varying presentation schemes (e.g., color scheme of displays, font size of text, etc.), aspects of media assets or advertisements displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The advertisement scheduling application may allow a user to provide user profile information or may automatically compile user profile information. The advertisement scheduling application may, for example, monitor the content the user accesses and/or other interactions the user may have with the advertisement scheduling application. Additionally, the advertisement scheduling application may obtain all or part of other user profiles that are related to a particular user (e.g., from other websites on the Internet the user accesses, such as www.allrovi.com or a particular social network, from other advertisement scheduling applications the user accesses, from other interactive applications the user accesses, from another user equipment device of the user, etc.), and/or obtain information about the user from other sources that the advertisement scheduling application may access. As a result, a user can be provided with a unified advertisement scheduling application experience across the user's different user equipment devices. This type of user experience is described in greater detail below in connection with FIG. 4. Additional personalized media guidance application features, which may be applicable to advertisement scheduling application features, are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

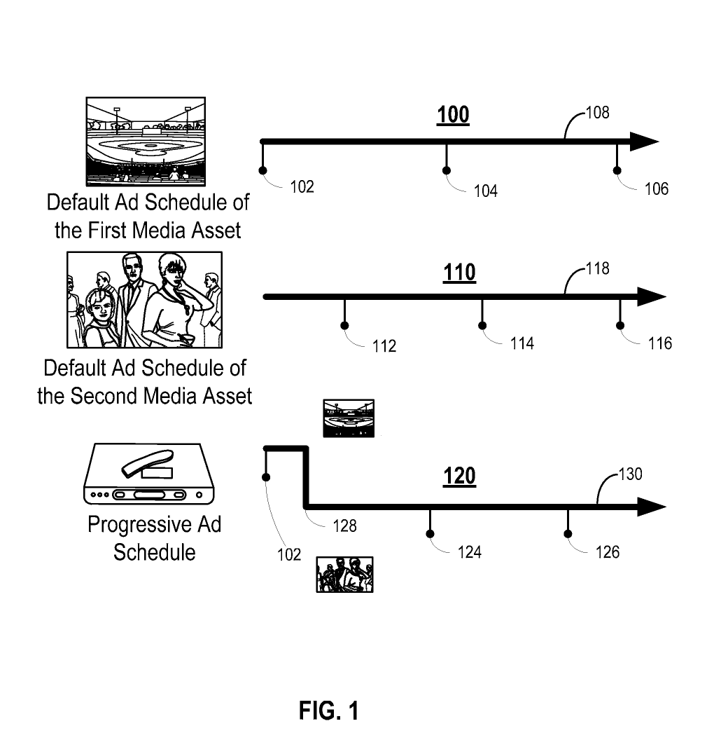

FIG. 1 shows an illustrative diagram displaying the advertisement scheduling application creating a progressive advertisement schedule in accordance with some embodiments of the disclosure. The advertisement schedules shown in FIG. 1 may be transmitted by the advertisement scheduling source 418 (FIG. 4), and the media assets associated with the advertisement schedules may be transmitted by content source 416 (FIG. 4). Data used to generate advertisement schedules may be transmitted on the communications network 414 (FIG. 4). User equipment 402, 404, and 406 (FIG. 4) may be used to run the advertisement scheduling application (e.g., via control circuitry 304 (FIG. 3), and transmit and/or receive data to the content source 416 (FIG. 4) and/or the advertisement scheduling source 418 (FIG. 4).

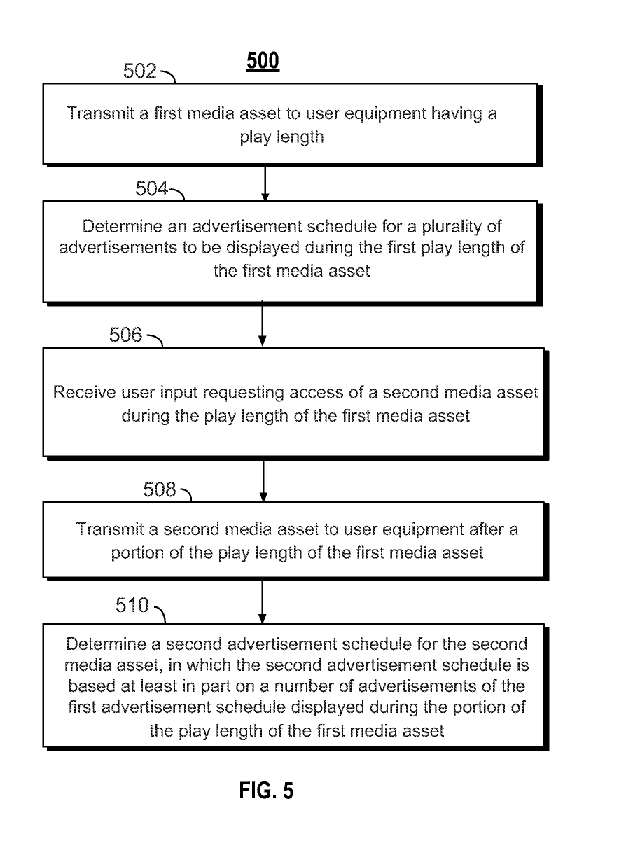

FIG. 1 displays three advertisement schedules. Advertisement schedule 100 is associated with a first media asset. Default advertisement schedule 110 is associated with a second media asset. Progressive advertisement schedule 120 has been generated by the advertisement scheduling application (e.g., via process 500 (FIG. 5) and is associated with the second media asset.

In some embodiments, FIG. 1 may represent a broadcast, in which the first and second media assets are television programs. In some embodiments, FIG. 1 may represent an on-demand or streaming media system, in which the first and second media assets are on-demand programs or webcasts. In some embodiments, FIG. 1 may represent a mixture of both a broadcast media system and an on-demand or streaming media system, in which one media asset is a broadcast television program and one media asset is a webcast.

Advertisement schedule 100 includes three advertisements 102, 104, and 106 during the play length 108 of the first media asset. During an advertisement (e.g., advertisement 102, 104, or 106), presentation of the first media asset is suspended. In some embodiments, a user may be presented with an advertisement on the display screen (e.g., display 312) of the device the user is using to access the first media asset (e.g., user equipment 402, 404, or 406 (FIG. 4). In some embodiments, advertisement schedule 100 may represent an advertisement schedule provided by default or provider by content source 416 (FIG. 4) with the first media asset. It should be noted that in some embodiments, advertisements 102, 104, and 106 may represent advertisement intervals with one or more advertisements.

Default advertisement schedule 110 includes three advertisements 112, 114, and 116 during the play length 118 of the second media asset. During an advertisement (e.g., advertisement 112, 114, or 116), presentation of the second media asset is suspended. In some embodiments, a user may be presented with an advertisement on the display screen (e.g., display 312) of the device the user is using to access the second media asset (e.g., user equipment 402, 404, or 406 (FIG. 4). In some embodiments, default advertisement schedule 110 may represent an advertisement schedule provided by default or provider by content source 416 (FIG. 4). It should be noted that in some embodiments, advertisements 112, 114, and 116 may represent advertisement intervals with one or more advertisements.

Progressive advertisement schedule 120 includes three advertisements 102, 124, and 126 during the viewing session 130. During viewing session 130, the user was initially viewing the first media asset, but changed channels to, or selected, the second media asset at time 128 during viewing session 130. Upon selecting the second media asset, the advertisement scheduling application generated a progressive advertisement schedule. Instead of the user receiving the default advertisement schedule 110 for the second media asset, the user received the progressive advertisement schedule 120.

Progressive advertisement schedule 120 differs from default advertisement schedule 110 as progressive advertisement schedule is based on both advertisement schedule 100 and default advertisement schedule 110 (e.g., as discussed below in relation to FIG. 5. During viewing session 130, the user viewed advertisement 102, while the user was viewing the first media asset. Progressive advertisement schedule 120 also has advertisements 124 and 126, which may be viewed by the user while the user views the second media asset.

Advertisements 124 and 126 are the result of the advertisement scheduling application generating progressive schedule 120. In some embodiments, advertisements 124 and 126 may occur at points in the presentation of the second media asset that are different from the points where advertisements 114 and 116 would have occurred in the presentation of the second media asset according to the default advertisement schedule 110. In some embodiments, advertisements 124 and 126 may also contain different content than advertisements 114 and 116 would have contained as discussed below in relation to process 1100 (FIG. 11). For example, the advertisements 124 and 126 may be longer or shorter than advertisements 114 and 116 would have been. In addition, advertisements 124 and 126 may show advertisements for products different from those that advertisements 114 and 116 would have shown.

In some embodiments, where advertisements 114, 116, 124 and 126 represent advertisement intervals featuring several advertisements, advertisements 124 and 126 may include a different number of advertisements, than advertisements 114 and 116 would have included in the presentation of the second media asset according to the default advertisement schedule 110.

For example, a user may be watching a first media asset (e.g., a sports program) on a first channel. The first channel or listing has a first advertisement schedule (e.g., advertisement schedule 100) of three advertisements, one at the beginning (e.g., advertisement 102), one at the fifteen minute mark (e.g., advertisement 104), and one at the thirty minute mark (e.g., advertisement 106) of play length 108. After five minutes, and after viewing the first advertisement in the advertisement schedule, the user decides to change to a second media asset (e.g., a drama) on a second channel. The second channel or listing has a default second advertisement schedule (e.g., default advertisement schedule 110) featuring three advertisements at the twelve minute, twenty minute, and thirty minute marks in play length 118.

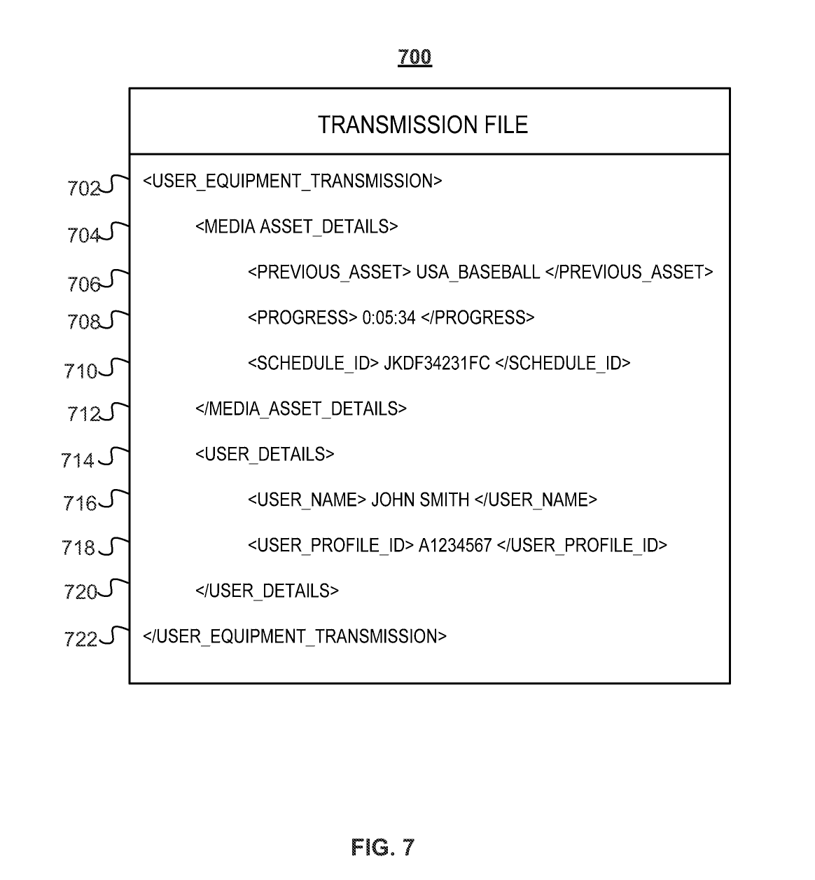

Processing the metadata (e.g., transmission file 700 (FIG. 7) associated with the advertisement schedule for the first media asset received with the user's channel change request (or selection of the second media asset listing), the advertisement scheduling application generates a progressive second advertisement schedule (e.g., progressive advertisement schedule 120) featuring two advertisements throughout the remainder of the user's viewing session, instead of the three advertisements that would have been shown under the default advertisement schedule, as the user already viewed the first advertisement (e.g., advertisement 102) associated with the first media asset. Therefore, the user is given credit for viewing the first advertisement associated with the first media asset.

In some embodiments, the advertisements shown in the progressive schedule may be different (e.g., higher or lower quality) or longer (e.g., an additional minute in length), than the advertisements shown according to a default advertisement schedule. Furthermore, in some embodiments, the position of the advertisements in the play length (e.g., play length 118) of the second media asset may be different. For example, advertisements 124 and 126 may now occur at the fourteen and twenty minute marks on the second media asset. In some embodiments, if a channel change, or a new media selection, is triggered during an advertisement or an advertisement interval, there may be a delay in tuning, or opening, the new media asset so that the currently present advertisement, or advertisement interval, could be completed. In some embodiments, the advertisement or advertisement interval may continue so that the new media asset may load or be cached, masking potential latency.

In some embodiments, the advertisement scheduling application may track the amount of advertisements or advertisement interval a user views, allowing a user to amass credits allowing the user to skip, either upon user input or automatically, future advertisements and advertisement intervals. In some embodiments, the credits may be stored or linked to a user's user profile.

It should be noted that the progressive advertisement schedule 120 may result from, or incorporate, one or more of the steps of the processes and/or embodiments described throughout this disclosure. In addition, progressive advertisement schedule 120 may be generated by, or used on, any of the user equipment devices or other devices (e.g., content source 416 and/or advertisement scheduling source 418) shown in FIGS. 3 and 4.

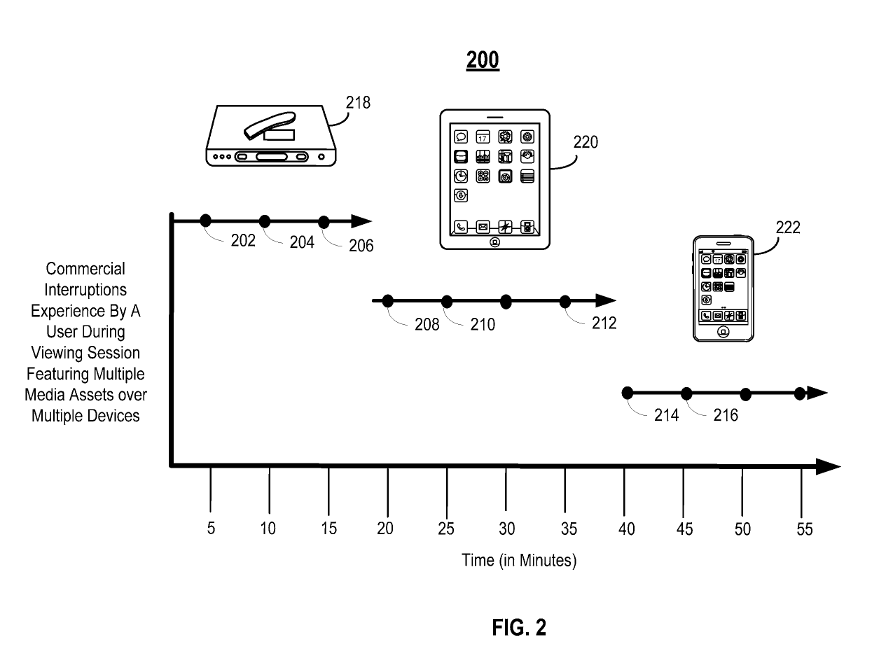

FIG. 2 shows an illustrative diagram displaying the advertisement scheduling application creating a progressive advertisement schedule across multiple platforms in accordance with some embodiments of the disclosure. FIG. 2 represents a variety of media assets (e.g., a broadcast television program, on-demand program, video game, or webcast) being played on multiple devices. In some embodiments, the advertisement scheduling application generates a progressive schedule across different platforms that are used by a user during a viewing session. In some embodiments, the media assets, on multiple devices, may be viewed in series or in parallel.

FIG. 2 shows a diagram displaying viewing session 200. Viewing session 200 occurs across three user equipment devices, set-top box 218, computer 220, and smartphone 222. During viewing session 200, the advertisement scheduling application coordinates the display of advertisements across the three devices. The advertisement scheduling application coordinates the advertisements into five minute intervals, while the user accesses a media asset on set-top box 218. For example, advertisement 202 occurs at five minutes into the viewing session, advertisement 204 occurs at ten minutes into the viewing session, and advertisement 206 occurs at fifteen minutes into the viewing session.

Between the fifteen and twenty minute mark into the viewing session 200, the user switches to the computer 220. In some embodiments, the advertisement scheduling application may determine that the user requested a new media asset on a different device via data (e.g., transmission file 700 (FIG. 7)) transmitted with the request. In some embodiments, the user may access the same or different media content. Although each media asset may have an individual advertisement schedule, the advertisement scheduling application generates a progressive advertisement schedule for the media asset accessed from computer 220; therefore, the five minute advertisement intervals are continued (e.g., as shown by advertisements 208 and 210).

At forty minutes into the viewing session 200, the user switches devices again. Because the last advertisement, advertisement 212, was shown exactly five minutes ago, the advertisement scheduling application generates advertisement 214 as the user accesses a media asset on smartphone 222. The advertisement scheduling application continues to maintain the progressive schedule and schedules advertisement 216 five minutes after advertisement 214.

It should be noted that the progressive advertisement schedule shown in viewing session 200 may result from, or incorporate, one or more of the steps of the processes and/or embodiments described throughout this disclosure. In addition, the progressive advertisement schedule shown in viewing session 200 may be generated by, or used on, any of the user equipment devices or other devices (e.g., content source 416 and/or advertisement scheduling source 418) shown in FIGS. 3 and 4. For example, the advertisement scheduling application may be implemented in software and/or hardware (e.g., using an application specific integrated circuit or a general purpose processor) as described below.

Users may access media assets and the advertisement scheduling application from one or more of their user equipment devices. FIG. 3 shows a generalized embodiment of illustrative user equipment device 300. More specific implementations of user equipment devices are discussed below in connection with FIG. 4 and may be used to control or operate the advertisement scheduling application. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and, specifically, processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, a multiple of the same type of processing units (e.g., two Intel Core i7 processors) or multiple different processors (e.g., an Intel Core i5 processor and an Intel Core i7 processor). In some embodiments, control circuitry 304 executes instructions for an advertisement scheduling application stored in memory (i.e., storage 308). Specifically, control circuitry 304 may be instructed by the advertisement scheduling application to perform the functions discussed above and below. For example, the advertisement scheduling application may provide instructions to control circuitry 304 to generate the advertisement schedules. In some implementations, any action performed by control circuitry 304 may be based on instructions received from the advertisement scheduling application.

In client-server based embodiments, control circuitry 304 may include communications circuitry suitable for communicating with an advertisement scheduling application server or other networks or servers. The instructions for carrying out the above-mentioned functionality may be stored on the advertisement scheduling application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application and advertisement scheduling data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions for channel change or media asset selection requests to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images.

In some embodiments, display 312 may be HDTV-capable. In some embodiments, display 312 may be a 3D display, and the interactive media guidance application, advertisement scheduling application, or advertisements resulting therefrom, and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. In some embodiments, the audio may be distributed to a receiver (not shown), which processes and outputs the audio via speakers 314.

The advertisement scheduling application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the advertisement scheduling application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the advertisement scheduling application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which an advertisement scheduling application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled, allowing for access to Internet content, while user computer equipment 404 may, like some television equipment 402, include a tuner allowing for access to television programming. The advertisement scheduling application may have the same layout on various different types of user equipment or may be tailored to the display capabilities of the user equipment. For example, on user computer equipment 404, the advertisement scheduling application may be provided as a website accessed by a web browser. In another example, the advertisement scheduling application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent advertisement scheduling application settings across in-home devices and remote devices. Settings include those described herein, as well as advertisement, channel, and program favorites, programming preferences that the advertisement scheduling application utilizes to make advertisement selections, display preferences, and other desirable advertisement scheduling settings. For example, if a an advertisement appears on a channel, for example, the website www.allrovi.com on a user's personal computer at his/her office, the same advertisement may appear on the user's in-home devices (e.g., user television equipment and user computer equipment) as well as the user's mobile devices, if desired. Likewise, an advertisement schedule applied to one device may apply to all devices. Therefore, changes made on one user equipment device can change the advertisement scheduling experience on another user equipment device, regardless of whether they are the same or a different type of user equipment device. In addition, the changes made may be based on settings input by a user, as well as user activity monitored by the advertisement scheduling application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that, in the exemplary embodiment shown in FIG. 4, it is a wireless path and paths 408 and 410 are drawn as solid lines to indicate they are wired paths (although these paths may be wireless paths, if desired).

Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and advertisement scheduling source 418 coupled to communications network 414 via communication paths 420 and 422, respectively. Paths 420 and 422 may include any of the communication paths described above in connection with paths 408, 410, and 412. Communications with the content source 416 and advertisement scheduling source 418 may be exchanged over one or more communications paths, but are shown as a single path in FIG. 4 to avoid overcomplicating the drawing. In addition, there may be more than one of each of content source 416 and advertisement scheduling source 418, but only one of each is shown in FIG. 4 to avoid overcomplicating the drawing. (The different types of each of these sources are discussed below.) If desired, content source 416 and advertisement scheduling source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416, which, in some embodiments, may be the source of a media asset, may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Advertisement scheduling source 418 may provide advertisement scheduling, such as the advertisement scheduling described above. Advertisement scheduling application data may be provided to the user equipment devices using any suitable approach. In some embodiments, the advertisement scheduling application may be a stand-alone interactive application that receives advertisement scheduling data via a data feed (e.g., a continuous feed or trickle feed). Advertisement scheduling data may be provided to the user equipment on a television channel sideband, using an in-band digital signal, using an out-of-band digital signal, or by any other suitable data transmission technique. Advertisement scheduling data may be provided to user equipment on multiple analog or digital television channels.

In some embodiments, the advertisement scheduling application may receive a media asset from content source 416 and an advertisement from advertisement scheduling source 418. The advertisement scheduling application may then determine a particular advertisement schedule for delivery to a user. For example, the advertisement scheduling application may receive the media asset and advertisement separately and combine them at user equipment 402, 404, and/or 406 to produce the advertisement schedule. In some embodiments, the advertisement scheduling application may be implemented on content source 416 and/or advertisement scheduling source 418 and transmit advertisement schedules to user equipment 402, 404, and/or 406. In some embodiments, the advertisement scheduling application may be implemented on user equipment 402, 404, and/or 406 and process and/or receive advertisement schedules, advertisement schedule data, and/or media assets.

In some embodiments, advertisement scheduling data from advertisement scheduling source 418 may be provided to users′ equipment using a client-server approach. For example, a user equipment device may pull advertisement scheduling data from a server, or a server may push advertisement scheduling data to a user equipment device. In some embodiments, an advertisement scheduling application client residing on the user's equipment may initiate sessions with advertisement scheduling source 418 to obtain advertisement scheduling data when needed, e.g., when the advertisement scheduling data is out of date or when the user equipment device receives a request from the user to receive data. Advertisement scheduling may be provided to the user equipment with any suitable frequency (e.g., continuously, daily, a user-specified period of time, a system-specified period of time, in response to a request from user equipment, etc.). Advertisement scheduling source 418 may provide user equipment devices 402, 404, and 406 the advertisement scheduling application itself or software updates for the advertisement scheduling application.

Advertisement scheduling applications may be, for example, stand-alone applications implemented on user equipment devices. For example, the advertisement scheduling application may be implemented as software or a set of executable instructions which may be stored in storage 308, and executed by control circuitry 304 of a user equipment device 300. In some embodiments, advertisement scheduling applications may be client-server applications where only a client application resides on the user equipment device, and server application resides on a remote server. For example, advertisement scheduling applications may be implemented partially as a client application on control circuitry 304 of user equipment device 300 and partially on a remote server as a server application (e.g., advertisement scheduling source 418) running on control circuitry of the remote server. When executed by control circuitry of the remote server (such as advertisement scheduling source 418), the advertisement scheduling application may instruct the control circuitry to generate the advertisement schedules and transmit the generated advertisement schedules to the user equipment devices. The server application may instruct the control circuitry of the advertisement scheduling source 418 to transmit data for storage on the user equipment. The client application may instruct control circuitry of the receiving user equipment to generate the advertisement scheduling application displays.

Content and/or advertisement scheduling data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide advertisement scheduling data described above. In addition to content and/or advertisement scheduling data, providers of OTT content can distribute advertisement scheduling applications (e.g., web-based applications or cloud-based applications), or the content can be displayed by advertisement scheduling applications stored on the user equipment device.

Advertisement scheduling system 400 is intended to illustrate a number of approaches, or network configurations, by which user equipment devices and sources of content and advertisement scheduling data may communicate with each other for the purpose of accessing content and providing advertisement scheduling. The embodiments described herein may be applied in any one or a subset of these approaches, or in a system employing other approaches for delivering content and providing advertisement scheduling. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various advertisement scheduling information or settings to be communicated between the different user equipment devices. For example, it may be desirable for users to maintain consistent advertisement scheduling application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain advertisement scheduling. For example, some users may have home networks that are accessed by in-home and mobile devices. Users may control in-home devices via an advertisement scheduling application implemented on a remote device. For example, users may access an online advertisement scheduling application on a website via a personal computer at their office, or a mobile device such as a PDA or web-enabled mobile telephone. The user may set various settings (e.g., recordings, reminders, or other settings) on the online advertisement scheduling application to control the user's in-home equipment. The online guide may control the user's equipment directly, or by communicating with an advertisement scheduling application on the user's in-home equipment. Various systems and methods for user equipment devices communicating, where the user equipment devices are in locations remote from each other, are discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their advertisement scheduling application to communicate directly with content source 416 to access content. Specifically, within a home, users of user television equipment 402 and user computer equipment 404 may access the advertisement scheduling application to provide advertisements. Users may also access the advertisement scheduling application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, which provide cloud-based services to various types of users and devices connected via a network such as the Internet via communications network 414. These cloud resources may include one or more content sources 416 and one or more advertisement scheduling sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, an advertisement scheduling application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

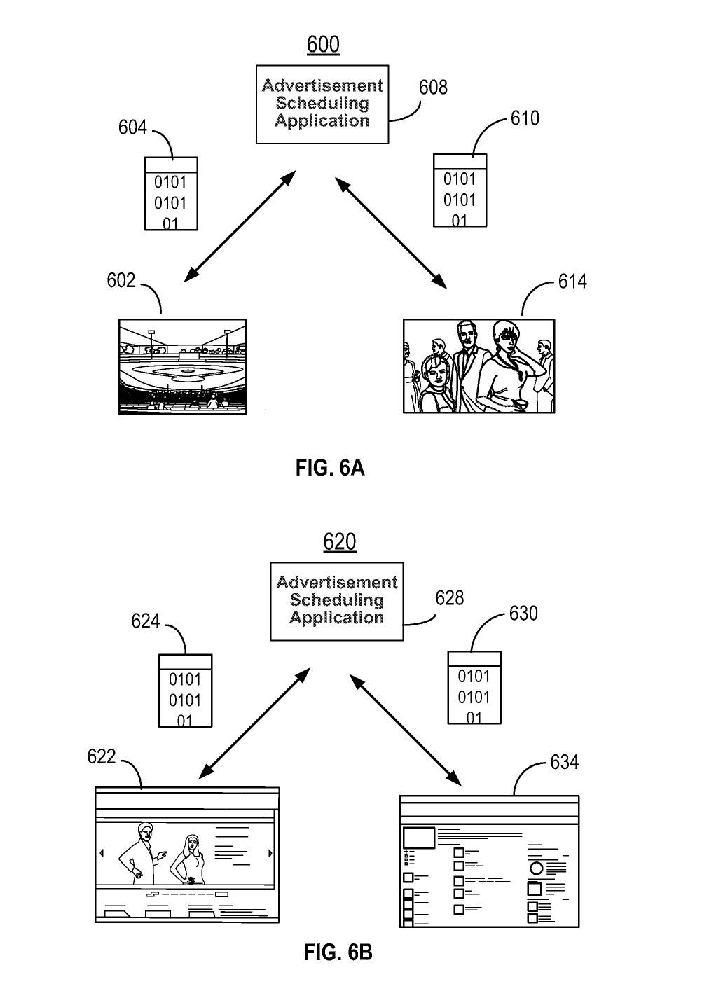

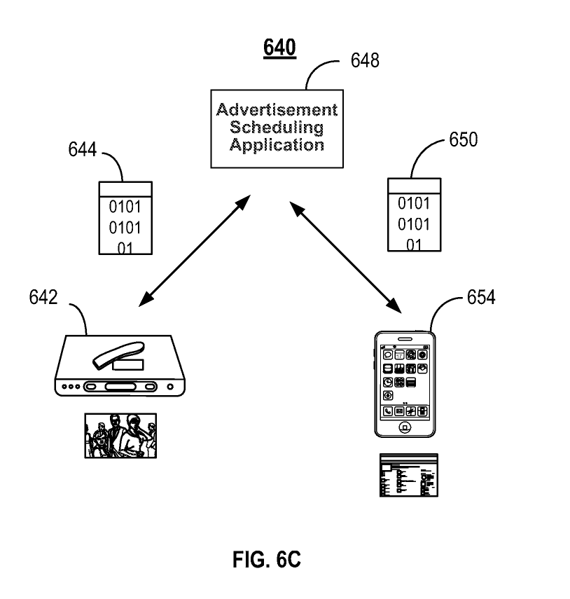

FIG. 5 is a flowchart of illustrative steps involved in using an advertisement scheduling application to create a progressive advertisement schedule in accordance with some embodiments of the disclosure. FIG. 5 describes process 500. It should be noted that the equipment or devices as shown and described in relation to FIGS. 3-4 may be used to perform any step in process 500. For example, in some embodiments, the advertisement scheduling application (e.g., advertisement scheduling application 608 (FIG. 6)) may by located on user equipment 402, 404, and 406 (FIG. 4) or advertisement scheduling source 418 (FIG. 4).

At step 502, the advertisement scheduling application transmits a first media asset to user equipment having a first play length. In some embodiments, a user may receive a first media asset (e.g., a broadcast movie or a webcast streamed via the Internet) on the user's user equipment (e.g., a television or computer). The advertisement scheduling application determines an advertisement schedule for a plurality of advertisements to be displayed during the first play length of the first media asset at step 504. For example, the advertisement scheduling application may generate a first advertisement schedule, which may include a particular number of advertisement intervals (e.g., commercial breaks) with a particular number of advertisements (e.g., commercials) in each interval. The media assets and advertisements may be displayed on display 312 (FIG. 3) of user equipment 402, 404, and 406 (FIG. 4).

In some embodiments, the first advertisement schedule may be received from the content provider (e.g., content source 416 (FIG. 4)) or the advertisement scheduling source 418 (FIG. 4)). The first advertisement schedule may incorporate parameters (e.g., the particular advertisement to display and/or the frequency of display) as requested by an advertiser. In some embodiments, the first advertisement schedule may be managed and/or generated by a third party. For example, in some embodiments, advertisement scheduling source 418 (FIG. 4) may represent a third party, which schedules advertisements to display on user equipment during media asset provided by a content provider.

At step 506, the advertisement scheduling application receives user input to transmit a second media asset during the play length of the first media asset. For example, a user may have tuned to a different channel or selected a new media asset to view using user input interface 310 (FIG. 3), and the advertisement scheduling application may receive the commands via control circuitry 304 (FIG. 3). In some embodiments, the command generated by the user input may be transmitted to the content provider (e.g., content source 416 (FIG. 4)).

In some embodiments, data (e.g., metadata) describing the first advertisement schedule and the point of progression in the play length of the first media asset may be transmitted to the advertisement scheduling application with a user input requesting access to another media asset. For example, in some embodiments, the advertisement scheduling application may interpret a transmission file (e.g., transmission file 700 (FIG. 7). The transmission file may identify the first advertisement schedule and the portion of the advertisement schedule (or first media asset play length) that was presented to the user.

At step 508, the advertisement scheduling application transmits a second media asset to user equipment after a portion of the play length of the first media asset. In some embodiments, a user may receive a second media asset (e.g., a different broadcast movie or a different webcast streamed via the Internet) on the user's user equipment (e.g., a television or computer). The advertisement scheduling application determines a second advertisement schedule for the second media asset, in which the second advertisement schedule is based at least in part on the number of advertisements displayed during the portion of the play length of the first media asset at step 510.

For example, the second advertisement schedule may include a particular number of advertisement intervals (e.g., commercial breaks) with a particular number of advertisements (e.g., commercials) in each interval. Moreover, the particular number of advertisement intervals and the particular number of advertisements in each interval may be based, at least in part on the advertisements presented during the first media asset. For example, if the first advertisement schedule presented a commercial to the user (e.g., on display 312 (FIG. 3) of user equipment 402, 404, and 406 (FIG. 4)), immediately before the user selected the second media asset, the advertisement scheduling application may delay the presentation of another advertisement interval until later in the presentation of the second media asset. In some embodiments, the advertisement scheduling application may increase the number of advertisements shown during the delayed advertisement interval. For example, if the advertisement interval that was delayed was scheduled to include one advertisement, the next advertisement interval may include an additional advertisement.

In some embodiments, the second advertisement schedule may be generated by/received from content source 416 (FIG. 4)), advertisement scheduling source 418 (FIG. 4)), user equipment 402, 404, 406 (FIG. 4), and/or any device accessible via communications network 414 (FIG. 4).

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method.

FIG. 6A shows a diagram of an illustrative media system displaying the advertisement scheduling source facilitating a progressive advertisement schedule in a broadcast system in accordance with some embodiments of the disclosure. FIG. 6A describes media system 600 in which a user changes from one broadcast media asset to another broadcast media asset. In media system 600, a user is accessing first media asset 602. Upon receiving a user input to change channels, for example as discussed in relation to step 506 (FIG. 5)), information regarding the advertisement schedule presented with first media asset 602 and the current point of progression in the play length of the first media asset is transmitted in transmission file 604 to advertisement scheduling application 608. In some embodiments, transmission file 604 may correspond with transmission file 700 (FIG. 700).

In some embodiments, advertisement scheduling application 608 may be located on content source 416 (FIG. 4), advertisement scheduling source 418 (FIG. 4), user equipment 402, 404, and 406 (FIG. 4), and/or any device accessible from the communications network (FIG. 4). In some embodiments, advertisement scheduling application 608 may receive instructions via control circuitry 304 (FIG. 3).

Advertisement scheduling application 608 also receives transmission file 610 with the second media asset 614. Transmission file 610 may indicate a default advertisement schedule for second media asset 614. In some embodiments, transmission file 610 may correspond to transmission file 700 (FIG. 7)). In some embodiments, advertisement scheduling application 608 may use the information in transmission file 604 and transmission file 610 to generate a progressive advertisement schedule as described in relation to process 500 (FIG. 5) for presentation during second media asset 614.

FIG. 6B shows a diagram of an illustrative media system displaying the advertisement scheduling source facilitating a progressive advertisement schedule in a streaming media system in accordance with some embodiments of the disclosure. FIG. 6B describes media system 620 in which a user changes from one streaming media asset to streaming media asset. In media system 620, a user is accessing first media asset 622. While accessing first media asset 622, a user may select a listing for second media asset 634. Selecting second media asset 634 may correspond to a user input as discussed in relation to step 506 (FIG. 5)). Upon selecting second media asset 634 information regarding the advertisement schedule presented with first media asset 622 and point of progression of the first media asset is transmitted in transmission file 624 to advertisement scheduling application 628. In some embodiments, transmission file 624 may correspond with transmission file 700 (FIG. 700).

In some embodiments, advertisement scheduling application 628 may be located on content source 416 (FIG. 4), advertisement scheduling source 418 (FIG. 4), user equipment 402, 404, and 406 (FIG. 4), and/or any device accessible from the communications network (FIG. 4). In some embodiments, advertisement scheduling application 628 may receive instructions via control circuitry 304 (FIG. 3).

Advertisement scheduling application 628 also receives transmission file 630 with the second media asset 634. Transmission file 610 may indicate a default advertisement schedule for second media asset 634. In some embodiments, transmission file 630 may correspond to transmission file 700 (FIG. 7)). In some embodiments, advertisement scheduling application 628 may use the information in transmission file 624 and transmission file 630 to generate a progressive advertisement schedule as described in relation to process 500 (FIG. 5) for presentation during second media asset 634.

FIG. 6C shows a diagram of an illustrative media system displaying the advertisement scheduling source facilitating a progressive advertisement schedule in a multi-platform system in accordance with some embodiments of the disclosure. FIG. 6C describes media system 640 in which a user changes between a broadcast media asset and a streaming and/or an on-demand media asset. In addition, FIG. 6C describes applying the advertisement scheduling application across different user devices (e.g., user equipment 402, 404, and 406 (FIG. 4)).

In media system 640, a user is accessing broadcast first media asset on first user device 642. While the user accesses the first media asset on first user device 642, transmission file 644 is being transmitted to advertisement scheduling application 648. Transmission file 644 indicates to advertisement scheduling application 648 the current advertisement schedule of the first media asset, the user's point of progress in the advertisement schedule, and the user associated with the first user device 642. While accessing broadcast media asset on first user device 642, the user may select a listing for a streaming media asset on second user device 654 as discussed in relation to step 506 (FIG. 5)).

Transmission file 650 indicates to advertisement scheduling application 648 the default advertisement schedule of the second media asset and the user associated with the second user device 654. In some embodiments, transmission file 644 and transmission file 650 may correspond with transmission file 700 (FIG. 700).

In some embodiments, advertisement scheduling application 648 may be located on content source 416 (FIG. 4), advertisement scheduling source 418 (FIG. 4), user equipment 402, 404, and 406 (FIG. 4), and/or any device accessible from the communications network (FIG. 4). In some embodiments, advertisement scheduling application 648 may receive instructions via control circuitry 304 (FIG. 3).

In some embodiments, advertisement scheduling application 648 may use the information in transmission file 644 and transmission file 650 to generate a progressive advertisement schedule as described in relation to process 500 (FIG. 5) for presentation during the second media asset presented on second user device 654. In some embodiments, advertisement scheduling application 648 may coordinate the advertisement schedules on both first user device 642 and second user device 654.

FIG. 7 shows an exemplary data structure for a transmission file associated with a media asset in accordance with some embodiments of the disclosure. In some embodiments, transmission file 700 may be included in data transmitted to the advertisement scheduling application (e.g., advertisement scheduling application 608 (FIG. 6)) used to generate a progressive advertisement schedule as described in relation to FIG. 5. In some embodiments, transmission file 700 may be processed using control circuitry 304 (FIG. 3). It should be noted that the information include in transmission file 700 is illustrative and should not be taken to be limiting in any way.

Transmission file 700 includes line 702. Line 702 indicates to the advertisement scheduling application (e.g., advertisement scheduling application 608 (FIG. 6)) that transmission file 700 is being received from user equipment (e.g., user equipment 402, 404, and 406 (FIG. 4). Transmission file 700 includes media asset information and user details information that may be used by the advertisement scheduling application to determine a progressive advertisement schedule for a media asset. Line 722 indicates to the advertisement scheduling application the end of the transmission file.

Line 704 indicates to the advertisement scheduling application the beginning of media asset details. The media asset details include the name of the media asset (e.g., line 706), the current point of progression in the play length of the media asset (e.g., line 708), and the particular advertisement schedule being used (e.g., line 710). For example, an advertisement schedule may be identified by an schedule identifier (e.g., line 710). The schedule identifier may identify the position and length of advertisement intervals within a media asset. The schedule identifier may also identify the type and amount of advertisements included in a media asset.

For example, by interpreting the schedule identifier (e.g., line 710) the advertisement scheduling application may identify the quality and/or quantity of advertisements that are to be presented during a media asset. In some embodiments, the advertisement scheduling application may use this information to determine a progressive advertisement schedule as described in relation to process 1100 (FIG. 11). In some embodiments, the advertisement scheduling application may compare the schedule identifier to a database (e.g., using a lookup table) to determine the particular advertisement schedule.

The media asset details may be used by the advertising scheduling application to determine numerous features related to the steps and processes described in FIG. 5. For example, by comparing the current point of progression in the play length of the media asset, the advertisement scheduling application may determine the particular point in the default advertisement schedule as well. For example, if the default advertisement schedule indicates that one advertisement will be shown at the five minute mark of the media asset, if the current point of progression is past the five minute mark, the advertisement scheduling application determines that one advertisement has been shown. Therefore, if a user changes to another media asset or device, the advertisement scheduling application knows the number of advertisements that were shown. Likewise, additional information needed for alternative or additional steps or processes as described above and below may be transmitted in the media asset details.

Line 712 indicates to the advertisement scheduling application the end of the media asset details. Line 714 indicates to the advertisement scheduling application the beginning of the user details. Transmission file 700 includes information on the name (e.g., line 716) and profile (e.g., line 718) of the user. Line 729 indicates of the advertisement scheduling application the end of the user details.

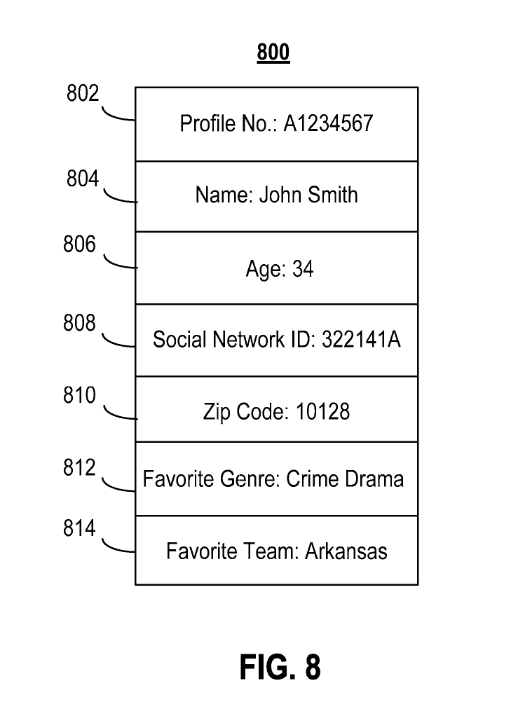

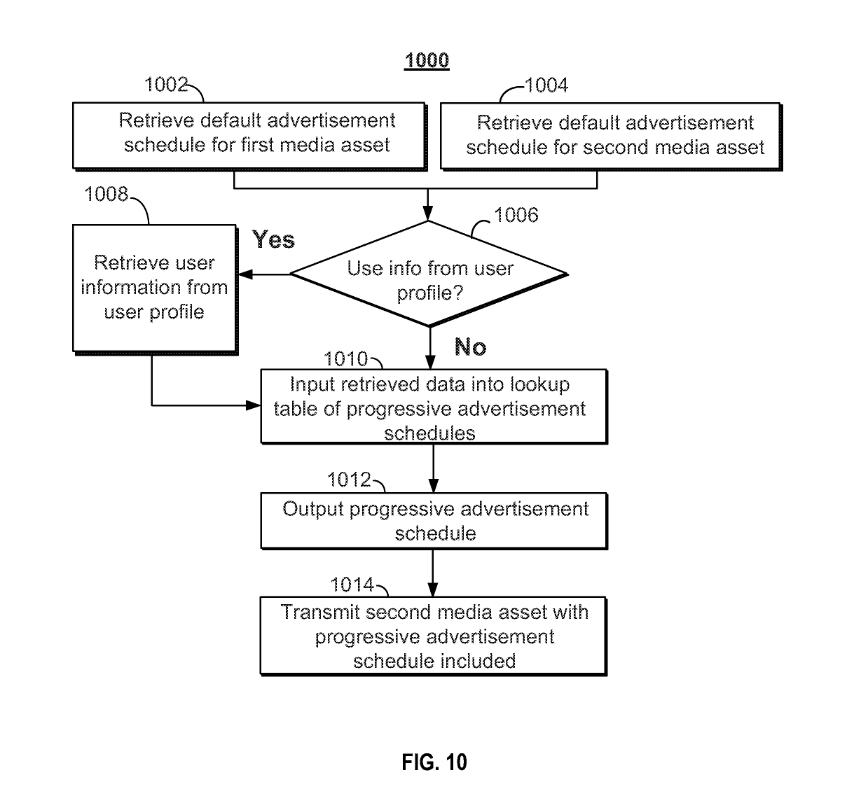

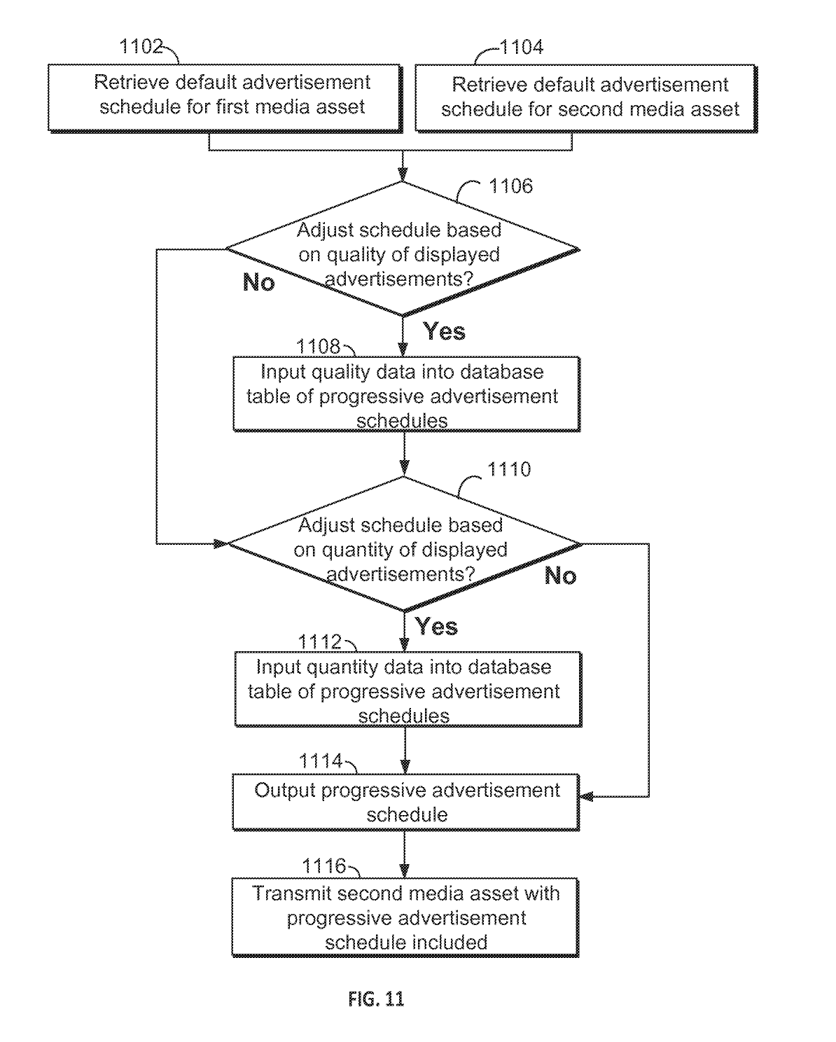

In some embodiments, the advertisement scheduling application may retrieve a user profile based on information included in a transmission file (e.g., line 718). In some embodiments, the advertisement scheduling application may use user profile information to determine a progressive advertisement schedule as discussed below in relation to FIG. 10. In some embodiments, information included in a transmission file (e.g., line 718) may be used to generate an array (e.g., array 800 (FIG. 8)) of user profile information. In some embodiments, user profile information included in a transmission file (e.g., line 718) may instruct the advertisement scheduling application to retrieve a user profile located at content source 416 (FIG. 4), advertisement scheduling source 418 (FIG. 4), user equipment 402, 404, or 406 (FIG. 4), or any other source accessible via the communications network 414 (FIG. 4).

It should be noted that the lines in transmission file 700 are illustrative only and not meant to be limiting. It is contemplated that additional, different, or fewer lines, which may represent any other information found in a transmission file, may also be included in some embodiments.

FIG. 8 shows an exemplary data structure for a compilation of data associated with a user profile in accordance with some embodiments of the disclosure, which may be transmitted to the advertisement scheduling application by content source 416 (FIG. 4), advertisement scheduling source 418 (FIG. 4), user equipment 402, 404, or 406 (FIG. 4), or any other source accessible via the communications network 414 (FIG. 4). Array 800 may be transmitted to the advertisement scheduling application in data (e.g., transmission file 700 (FIG. 7)) accompanying the media asset. In some embodiments, array 800 may be received by control circuitry 304 (FIG. 3) to provide information to the advertisement scheduling application.

In some embodiments, a user profile may be located locally or remotely. For example, a user profile may be located at content source 416 (FIG. 4), advertisement scheduling source 418 (FIG. 4), user equipment 402, 404, or 406 (FIG. 4), or any other source accessible via the communications network 414 (FIG. 4).

In some embodiments, user profile information received in array 800 may provide, at least in part, the basis for determining the progressive advertisement schedule in relation to step 510 of process 500 (FIG. 5). It should be noted that the information presented in array 800 is illustrative and is not meant to be limiting as to the amount or type of information that may be transmitted to the advertisement scheduling application.

Array 800 includes data field 802. Data field 802 indicates to the advertisement scheduling application the profile number associated with array 800. The profile number may correspond to a profile identifier (e.g., line 718) found in a transmission file (e.g., transmission file 700 (FIG. 7)) transmitted with a media asset or a request for another media asset.

Data field 804 indicates to the advertisement scheduling application the name of the user associated with the user device on which the user is accessing the media asset. In some embodiments, the advertisement scheduling application may use information regarding the user associated with a particular device (e.g., user equipment 402, 404, and 406 (FIG. 4)) to coordinate a progressive advertisement schedule between multiple devices (e.g., as described in relation to FIGS. 2 and 6C).

Data fields 806 through 814 indicate to the advertisement scheduling application information about the user such as the user's age (e.g., data field 806), social network profiles associated with the user (e.g., data field 808), the geographic location of the user (e.g., data field 810), and interests or preferences of the user (e.g., data field 812 and data field 814). Information about the user may be processed by the advertisement scheduling application to determine the particular advertisement to present to a user. In addition to targeting the content of advertisements, the advertisement scheduling application may determine process the information to determine a progressive advertisement schedule. For example, the advertisement scheduling application may determine that a user with an age of “34” will likely tolerate only advertisement intervals that are four minutes long and occur only every fifteen minutes during a media asset. In another example, the advertisement scheduling application may determine that the media asset being presented is a user's favorite program; therefore, the advertisement scheduling application may determine that the user will tolerate longer advertisement intervals during this media asset as opposed to a media asset that is not the favorite program of the user.

It should be noted that the data fields in array 800 are illustrative only and not meant to be limiting. It is contemplated that additional, different, or fewer data fields, which may represent any other information found in a user profile, may also be included in some embodiments.

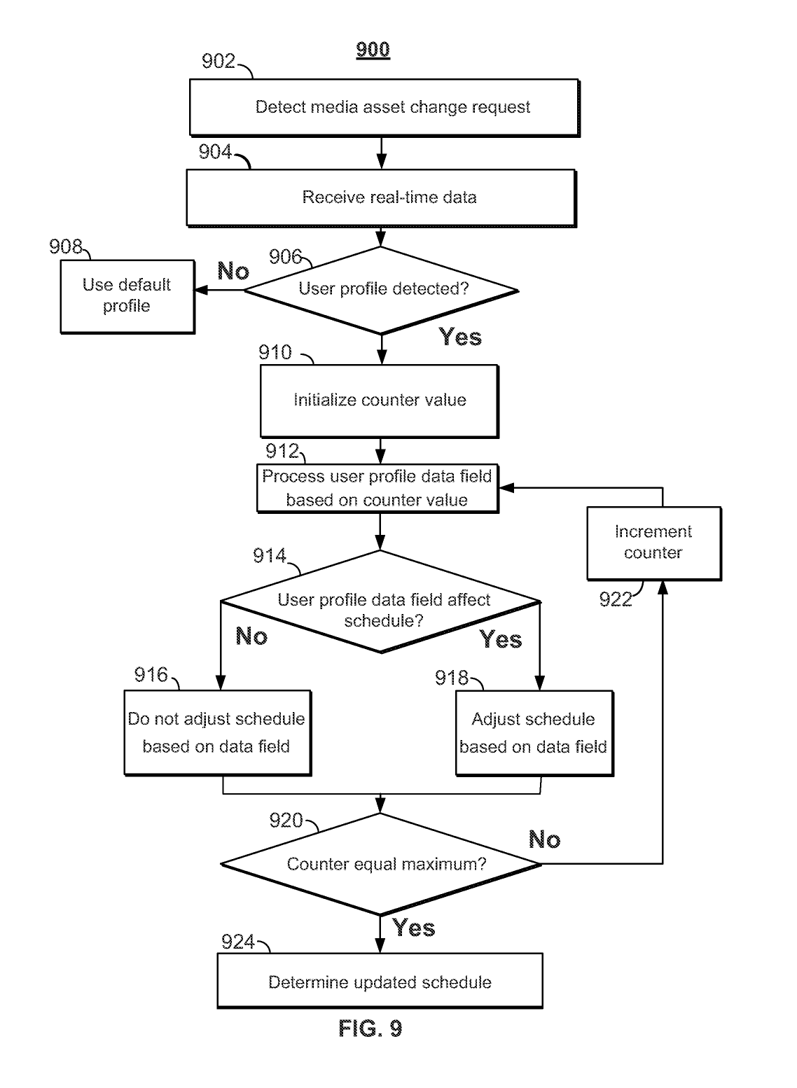

FIG. 9 is a flowchart of illustrative steps involved for generating a progressive advertisement schedule based on a user profile in accordance with some embodiments of the disclosure. In some embodiments, process 900 may process an array of data fields (e.g., array 800 (FIG. 8)). It should be noted that any of the equipment or devices as shown and described in relation to FIGS. 3-4 may be used to perform any step in process 900. For example, in some embodiments, the advertisement scheduling application (e.g., advertisement scheduling application 608 (FIG. 6)) may by located on user equipment 402, 404, and 406 (FIG. 4), advertisement scheduling source 418 (FIG. 4), and/or any device accessible via communications network 414 (FIG. 4).

At step 902, process 900 detects a media asset change request. In some embodiments, step 902 may correspond to step 506 (FIG. 5). For example, a user may have tuned user equipment (e.g., user equipment 402, 404, and 406 (FIG. 4)) to a different channel or selected a new media asset listing for presentation on the user equipment. At step 904, process 900 receives data (e.g., transmission file 700 (FIG. 7)).

At step 906, process 900 determines whether or not a user profile is detected. For example, the advertisement scheduling application may process the data (e.g., transmission file 700 (FIG. 7)) to determine if there is a user profile identifier (e.g., line 718 (FIG. 7)). If process 900 does not detect a user profile, process 900 uses a default profile at step 908. In some embodiment, a default profile may be a profile automatically referenced when generating a progressive advertisement schedule if a user profile is not available. If process 900 detects a user profile, process 900 continues to step 910.

At step 910, process 900 initializes a counter value (e.g., setting a counter value to one). At step 912, process 900 processes a user profile data field based on the counter value. For example, in some embodiments, the user profile is arranged in an array (e.g., array 800 (FIG. 8)). Upon the one iteration, process 900 may process one data field (e.g., data field 806 (FIG. 8)). During a subsequent iteration, based on the incremented counter value, process 900 may process the next data field (e.g., data field 808).

At step 914, process 900 determines if the processed user profile data for the data field affect the progressive advertisement schedule. For example, the data field may indicate that the user will tolerate longer advertisement intervals in media assets, for media assets viewed on a particular device. Therefore, if the user is viewing a media asset from the particular device, the progressive advertisement schedule may include longer advertisement intervals.

If the data affects the advertisement schedule, process 900 adjusts the advertisement schedule at step 918. If the advertisement schedule is not affected, process 900 does not adjust the advertisement schedule at step 916. At step 920, process 900 determines if the counter has reached its maximum. If the counter has not reached its maximum, then the counter value is incremented at step 922, and process 900 returns to step 912. If the counter has reached its maximum, process 900 continues to step 924. At step 924, process 900 determines an updated schedule based on the user profile.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

FIG. 10 is a flowchart of illustrative steps involved for determining a progressive advertisement schedule based on multiple advertisement schedules in accordance with some embodiments of the disclosure. It should be noted that and of the equipment or devices as shown and described in relation to FIGS. 3-4 may be used to perform any step in process 1000. For example, in some embodiments, the advertisement scheduling application (e.g., advertisement scheduling application 608 (FIG. 6)) may be located on user equipment 402, 404, and 406 (FIG. 4), advertisement scheduling source 418 (FIG. 4), and/or any device accessible via communications network 414 (FIG. 4).

FIG. 10 describes process 1000, which retrieves multiple advertisement schedules and user profile information, and inputs the information into a lookup data to determine a progressive advertisement schedule. At step 1002, process 1000 retrieves a default advertisement schedule for a first media asset. In some embodiments, step 1002 may correspond to step 502 (FIG. 5). At step 1004, process 1000 retrieves a default advertisement schedule for a second media asset. In some embodiments, the default advertisement may be determined by a content provider and/or third party facilitator and received from content source 416 (FIG. 4) and/or advertisement scheduling source 418 (FIG. 4).

At step 1006, process 1000 determines whether or not to use information from a user profile to determine a progressive advertisement schedule. In some embodiments, this may include searching for a user profile identifier (e.g., line 718 (FIG. 7)) or receiving instructions (e.g., via a content or advertisement provider). If a user profile is used, process 1000 retrieves user profile information from a user profile at step 1008 and proceeds to step 1010. If a user profile is not used, process 1000 proceeds directly to step 1010.

At step 1010, process 1000 inputs the retrieved data into a lookup table of progressive advertisement schedules. For example, the advertisement scheduling application may reference a database, which includes a plurality of progressive advertisement schedules. The database may filter the progressive advertisement schedules based on inputs from the default advertisement schedule for the first media asset (e.g., the number of advertisement intervals, advertisements in each interval, and the number of advertisements presented to a user). In addition, database may filter the progressive advertisement schedules based on inputs from the default advertisement schedule (e.g., the number of advertisement intervals and advertisements in each interval to be presented during the second media asset), and any inputs received from the user profile, if used (e.g., the number of advertisements the user will tolerate during an advertisement interval).

At step 1012, process 1000 outputs a progressive advertisement schedule. Process 1000 then transmits the progressive advertisement schedule, along with the second media asset to the user at step 1014. The user may receive the second media asset, on the user's user equipment (e.g., user equipment 402, 404, and 406 (FIG. 4)).

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method.

FIG. 11 is a flowchart of illustrative steps involved for determining a progressive advertisement schedule based on a the quality and quantity of advertisements in a first advertisement schedule in accordance with some embodiments of the disclosure. It should be noted that and of the equipment or devices as shown and described in relation to FIGS. 3-4 may be used to perform any step in process 1100. For example, in some embodiments, the advertisement scheduling application (e.g., advertisement scheduling application 608 (FIG. 6)) may be located on user equipment 402, 404, and 406 (FIG. 4), advertisement scheduling source 418 (FIG. 4), and/or any device accessible via communications network 414 (FIG. 4).

FIG. 11 describes process 1100, which incorporates the quality of advertisements to determine a progressive advertisement schedule. At step 1102, process 1100 retrieves a default advertisement schedule for a first media asset. In some embodiments, step 1102 may correspond to step 502 (FIG. 5). At step 1104 process 1100 retrieves a default advertisement schedule for a second media asset. In some embodiments, the default advertisement may be determined by a content provider and/or third party facilitator and received from content source 416 (FIG. 4) and/or advertisement scheduling source 418 (FIG. 4).

At step 1106, process 1100 determines whether or not to adjust the progressive schedule based on the quality of the first advertisements in the default advertisement schedule of the first media asset. For example, in some embodiments, the advertisement scheduling application may adjust the number of advertisements a user may be presented with based on the quality of advertisements a user has already been presented with. For example, if a user has already viewed a high quality pre-roll advertisement for one media asset, the user will not be required to view several low quality advertisements for another media asset.

If the progressive schedule is adjusted based on the quality of the first advertisements, process 1100 inputs the quality data received with the default advertisement schedule of the first media asset into a database which filters the progressive advertisement schedules based on the inputted quality data at step 1108 and proceeds to step 1110. For example, a look up table may be used to determine the particular quality of a given advertisement. The look up table may be located at any of the devices shown and described in FIGS. 3-4. If the progressive schedule is not adjusted based on the quality of the displayed advertisements (e.g., in an embodiment in which quality data is not transmitted), process 1100 proceeds to step 1110.

At step 1110, process 1100 determines whether or not to adjust the progressive schedule based on the quantity of the second advertisements in the second advertisement schedule. If the progressive schedule is adjusted based on the quantity of the second advertisements, process 1100 inputs the retrieved data into database, which filters the progressive advertisement schedules based on inputted data at step 1112 and proceeds to step 1114. For example, if a user has already watch a certain number of advertisements the advertisement scheduling application may defer or eliminate one or more advertisements in the progressive advertisement schedule. If the progressive schedule is not adjusted based on the quantity of the second advertisements (e.g., in an embodiment in which quantity data is not transmitted), process 1100 and proceeds to step 1114.

At step 1114, process 1100 outputs a progressive advertisement schedule. Process 1100 then transmits the progressive advertisement schedule along with the second media asset to the user at step 1116. The user may receive the second media asset on the user's user equipment (e.g., user equipment 402, 404, and 406 (FIG. 4)).

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, each of these steps may be performed in any order or in parallel or substantially simultaneously to reduce lag or increase the speed of the system or method.

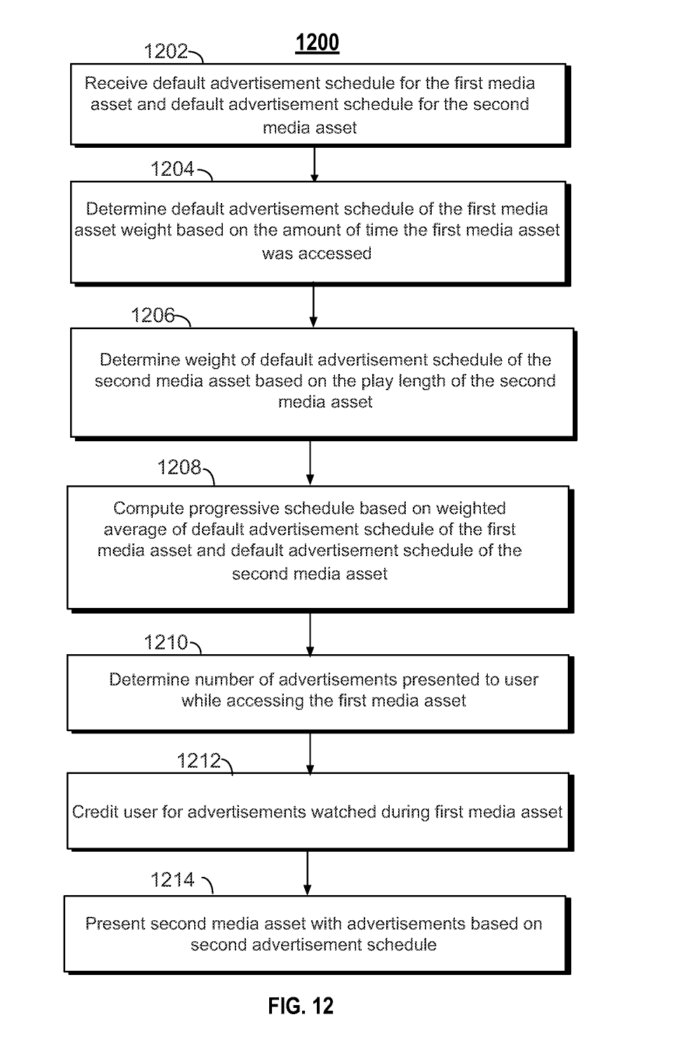

FIG. 12 is a flowchart of illustrative steps involved for determining a progressive advertisement schedule based on multiple advertisement schedules and advertisements already presented to a user in accordance with some embodiments of the disclosure. It should be noted that the equipment or devices as shown and described in relation to FIGS. 3-4 may be used to perform any step in process 1200. For example, in some embodiments, the advertisement scheduling application (e.g., advertisement scheduling application 608 (FIG. 6)) may by located on user equipment 402, 404, and 406 (FIG. 4), advertisement scheduling source 418 (FIG. 4), and/or any device accessible via communications network 414 (FIG. 4).

FIG. 12 describes process 1200, which weighs the default advertisement schedule for the first media asset and the default advertisement schedule for the second media asset according to the amount of time that a user accessed either media asset. For example, a user may only view a first media asset for a few seconds before selecting the second media asset; therefore, the default advertisement schedule of the first media asset may be weighed less heavily than the default advertisement schedule for the second media asset. In some embodiments, process 1200 may also incorporate one or more steps of process 1100 (FIG. 11). In some embodiments, process 1200 may also incorporate one or more steps from process 1000 (FIG. 10). In addition, process 1200 may be adjusted to weigh one or more inputs from a user profile.

At step 1202, process 1200 receives a default advertisement schedule for the first media asset and default advertisement schedule for the second media asset. In some embodiments, step 1102 may correspond to step 502 (FIG. 5). At step 1104 process 1100 retrieves a default advertisement schedule for a second media asset. In some embodiments, the default advertisement may be determined by a content provider and/or third party facilitator and received from content source 416 (FIG. 4) and/or advertisement scheduling source 418 (FIG. 4).

At step 1204, process 1200 determines the default advertisement schedule of the first media asset weight based on the amount of time the first media asset was accessed. In some embodiments, the weight may be accessed based on the actual length of time that the first media asset was accessed or may be based on the percentage of the play length of the first media asset that was accessed. In some embodiments, the advertisement scheduling application may segment the first media asset wherein each segments accessed adds weight to the default advertisement schedule of the first media asset. In some embodiments, the advertisement scheduling application may determine the weight based on the number of advertisements watched, or not watched, during the media asset. In some embodiments, the advertisement scheduling application may determine weight based on the quality or popularity of the first media asset.

At step 1206, process 1200 determines the weight of the default advertisement schedule of the second media asset based on the play length of the second media asset. In some embodiments, the weight of the default advertisement schedule of the second media asset may be determined using alternative methods. For example, in some embodiments, the weight of the default advertisement schedule may be determined based on the quality of the advertisements or the number of advertisements or advertisement intervals scheduled to be shown as described in FIG. 11. In some embodiments, the advertisement scheduling application may determine the weight based on the quality or popularity of the second media asset.

At step 1208, process 1200 computes a progressive schedule based on the weighted average of default advertisement schedule of the first media asset and default advertisement schedule of the second media asset. In some embodiments, process 1200 may incorporate other suitable methods of combining the default advertisement schedule of the first media asset and default advertisement schedule of the second media asset to produce a progressive advertisement schedule.

At step 1210, process 1200 determines a number of advertisements presented to the user while the user accessed the first media asset. In some embodiments, the advertisement scheduling application may compare the point of progression in the play length of the first media asset as indicated by data (e.g., line 708 (FIG. 7)) to the advertisement schedule (e.g., line 710 (FIG. 7)) to determine the number of advertisements presented.

In some embodiments, the advertisement scheduling application (e.g., advertisement scheduling application 608 (FIG. 6)) may determine an allocation associated with the portion of the first media asset before the user selects the second media asset. As used herein, an “allocation” of an advertisement refers to the number of advertisement that should be displayed per a particular amount of time of the play length of a media asset. For example, if one advertisement is allocated to twenty minutes of the play length of a media asset, then for each twenty minutes of the media asset that is displayed to the user, a single advertisement should also be shown. The length of the advertisement may vary. For example, after twenty minutes of a media asset is displayed, the advertisement scheduling application may display a two minute, or any other length of time, advertisement. For example, the first media asset may have three advertisements during the hour long play length of the first media asset. One two-minute advertisement, for example, may, therefore, be allocated to one third of the play length of the media asset. For example, if a user has watched one advertisement, the user is allocated to watch one third of the first media asset. If the user selects the second media asset before viewing the entire first third of the first media asset, the advertisement shown during the first media asset may be over-allocated. If the user selects the second media asset after viewing the entire first third of the first media asset, the advertisement shown during the first media asset may be under-allocated.

If an advertisement is over-allocated for the play length of a media asset that a user accessed, the advertisement scheduling application may reduce the amount of subsequent advertisements shown during a particular play length of a media asset in order to correct the over-allocation. Conversely, if an advertisement is under-allocated for the play length of a media asset that a user accessed, the advertisement scheduling application may increase the amount of subsequent advertisements shown during a particular play length of a media asset in order to correct the under-allocation

In some embodiments, whether or not an advertisement is over or under allocated may factor into the weighing of the default advertisement schedule for the first media asset and the default advertisement schedule for the second media asset. In addition, in some embodiments, revenue attributed to content and/or advertisement providers may be accounted for based on the allocation. For example, if the advertisement shown during the first media asset is under allocated for the content and/or advertisement provider of the first media asset, or the advertisement shown during the first media asset may receive an accounting from the content and/or advertisement provider of the second media asset, or the advertisement shown during the second media asset.

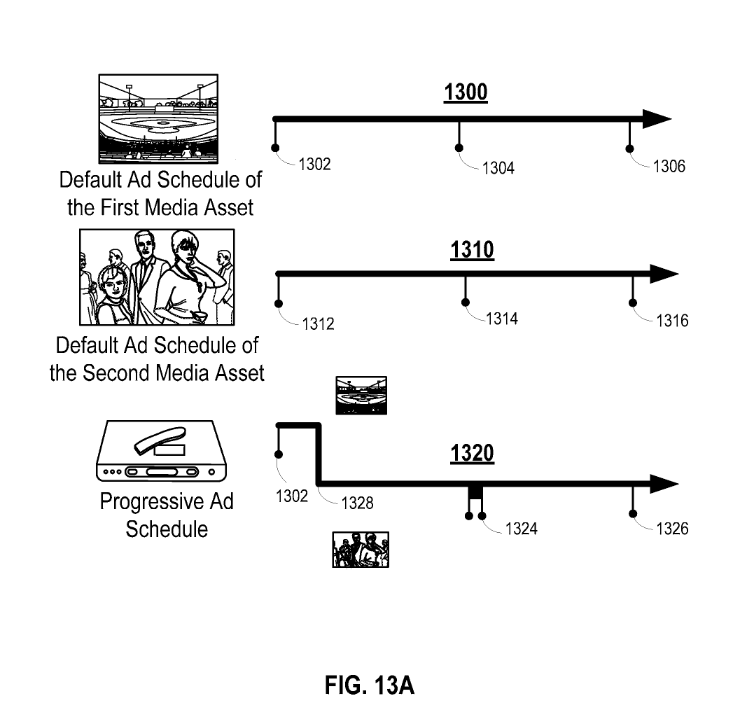

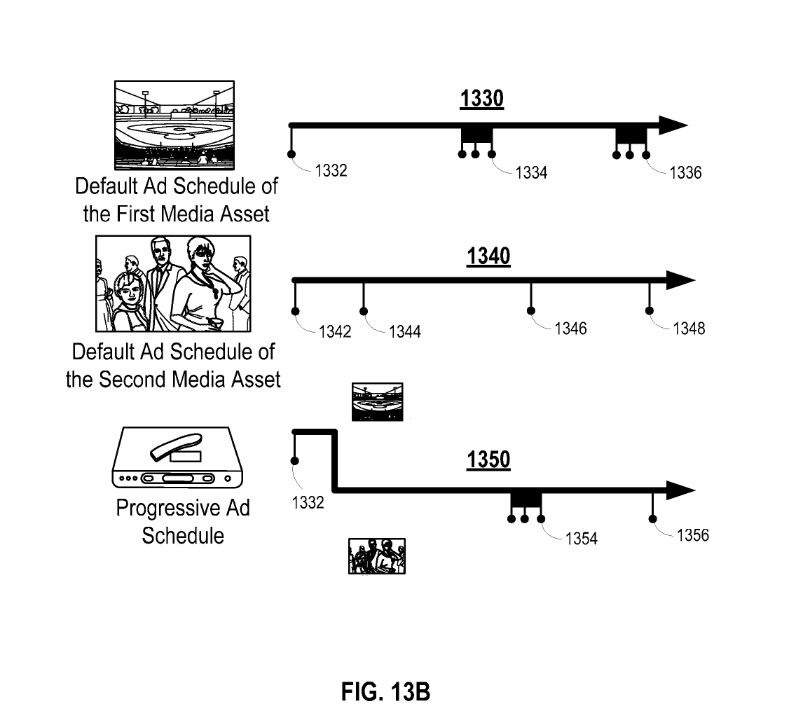

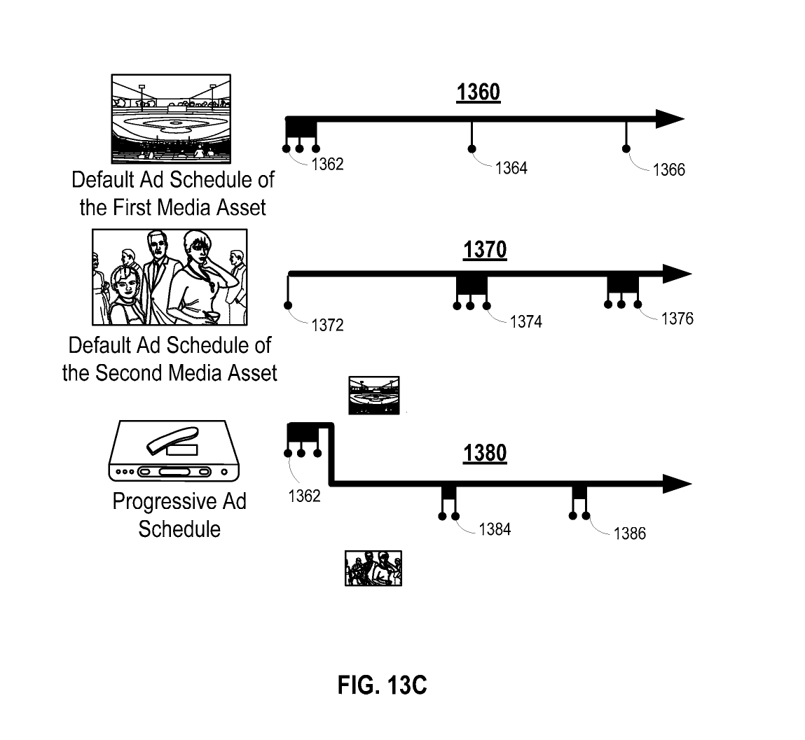

At step 1212, process 1200 credits a user for advertisements watched during first media asset. For example, if a user watches one advertisement during the first media asset, the progressive advertisement schedule may skip or delay the presentation of an advertisement during the second media asset. Skipping and delaying advertisements during the progressive advertisement schedule is discussed below in regard to FIGS. 13A-C. At step 1214, process 1200 presents a second media asset with advertisements based on the second advertisement schedule. In some embodiments, a user may be presented with an advertisement on the display screen (e.g., display 312) of the device the user is using to access the first media asset (e.g., user equipment 402, 404, or 406 (FIG. 4).

It is contemplated that the steps or descriptions of FIG. 12 may be used with any other embodiment of this disclosure. In addition, the steps and descriptions described in relation to FIG. 12 may be done in alternative orders or in parallel to further the purposes of this disclosure. For example, each of these steps may be performed in any order or in parallel or substantially simultaneously to reduce lag or increase the speed of the system or method.

FIG. 13A-C show several illustrative embodiments of the progressive advertisement schedule as determined by an advertisement scheduling application for use in broadcast and on-demand media assets. FIG. 13A shows a default advertisement schedule for the first media asset 1300 for the first media asset and default advertisement schedule 1310 for the second media asset. Advertisement schedule 1300 includes three advertisement intervals with one advertisement in each interval (e.g., advertisement intervals 1302, 1304, and 1306). Default advertisement schedule 1310 also includes three advertisement intervals with one advertisement in each interval (e.g., advertisement intervals 1312, 1314, and 1316). In both schedules, the three advertisement intervals are located at the zero (or pre-roll) minute mark, the fifteen minute mark, and the thirty minute mark.

Progressive advertisement schedule 1320 shows a user's advertisement schedule as determined by the advertisement scheduling application in some embodiments. For example, progressive advertisement schedule 1320 may have been determined by process 500 (FIG. 5). After viewing advertisement interval 1302, the user selects a new media listing as indicated by point 1328. As the user has already watched a pre-roll advertisement, the progressive advertisement schedule does not require the user to view a pre-roll advertisement for the second media asset. Instead, progressive advertisement schedule 1320 includes another advertisement in advertisement interval 1324 as well as a single advertisement in advertisement interval 1326.

FIG. 13B shows advertisement schedule 1330 for the first media asset and default advertisement schedule 1340 for the second media asset. Advertisement schedule 1330 includes three advertisement intervals with one advertisement in advertisement interval 1332 and three advertisements in advertisement interval 1334 and advertisement interval 1336. The three advertisement intervals are located at the zero (or pre-roll) minute mark, the fifteen minute mark, and the thirty minute mark. Default advertisement schedule 1340 includes four advertisement intervals with one advertisement in each interval (e.g., advertisement intervals 1342, 1344, 1346, and 1348). The four advertisement intervals are located at the zero (or pre-roll) minute mark, the ten minute mark, twenty minute mark, and the thirty minute mark.

Progressive advertisement schedule 1350 shows a user's advertisement schedule as determined by the advertisement scheduling application in some embodiments. For example, progressive advertisement schedule 1350 may have been determined by one or more steps of the processes described in FIGS. 5, 9, 10, 11, and/or 12. After viewing advertisement interval 1332, the user selects a new media listing. As the user has already watched a pre-roll advertisement, the progressive advertisement schedule does not require the user to view a pre-roll advertisement for the second media asset. In addition, progressive advertisement schedule 1350 skips the next advertisement interval. Instead, progressive advertisement schedule 1350 includes three advertisements in advertisement interval 1354 as well as a single advertisement in advertisement interval 1356. By adjusting the number of advertisements and intervals, the advertisement scheduling application can enhance the viewing experience of the user. By adjusting when the advertisement intervals are displayed, the advertisement scheduling application may prevent the user from becoming frustrated that the media asset is being interrupted with advertisement intervals too often.

FIG. 13C shows advertisement schedule 1360 for the first media asset and default advertisement schedule 1370 for the second media asset. Advertisement schedule 1360 includes three advertisement intervals with three advertisements in advertisement interval 1362 and one advertisement in advertisement intervals 1364 and 1366. The three advertisement intervals are located at the zero (or pre-roll) minute mark, the fifteen minute mark, and the thirty minute mark. Default advertisement schedule 1370 includes three advertisement intervals with one advertisement in advertisement interval 1372 and three advertisements in advertisement interval 1374 and advertisement interval 1376. The three advertisement intervals are located at the zero, or pre-roll, minute mark (e.g., advertisement interval 1372), the fifteen minute mark (e.g., advertisement interval 1374), and the thirty minute mark (e.g., advertisement interval 1376).

Progressive advertisement schedule 1380 shows a user's advertisement schedule as determined by the advertisement scheduling application in some embodiments. For example, progressive advertisement schedule 1380 may have been determined by process 500 (FIG. 5). After viewing advertisement interval 1362, the user selects a new media listing. As the user has already watched an advertisement interval with three advertisements, the progressive advertisement schedule does not require the user to view all advertisements of the default advertisement schedule 1370. Instead, progressive advertisement schedule 1350 includes only two advertisements in advertisement interval 1384 and advertisement interval 1386. By adjusting the number of advertisements in the intervals, the advertisement scheduling application can enhance the viewing experience of the user. By adjusting the amount of advertisements in each interval, the advertisement scheduling application may prevent the user from becoming frustrated that advertisement intervals are too long.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. It should also be noted, the systems and/or methods described above may be applied to, or used in accordance with, other systems and/or methods.

1. A method for transmitting advertisements associated with media assets, the method comprising:
transmitting a first media asset to user equipment, said first media asset having a first play length;
determining a first advertisement schedule for a plurality of advertisements to be displayed during the first play length of the first media asset;
receiving a user input requesting access of a second media asset during the first play length;
transmitting the second media asset to the user equipment after a portion of the first play length;
determining a second advertisement schedule for the second media asset, wherein the second advertisement schedule is based at least in part on a number of advertisements of the first advertisement schedule displayed during the portion of the first play length.

2. The method of claim 1, further comprising determining a default advertisement schedule for the second media asset, wherein the second advertisement schedule is further based at least in part on the default advertisement schedule for the second media asset.

3. The method of claim 1, wherein the second advertisement schedule comprises a number of advertisement intervals.

4. The method of claim 3, wherein the number of advertisement intervals and each advertisement interval's location in the second media asset is based at least in part on the number of advertisements displayed during the portion of the first play length.

5. The method of claim 1, further comprising determining an allocation of advertisements associated with the portion of the first play length, wherein the number of advertisements in the second schedule is based at least in part on the allocation.

6. The method of claim 1, wherein the number of advertisements in the second schedule is further based on a quality associated with the advertisements displayed during the portion of the first play length.

7. The method of claim 1, wherein the first media asset is displayed on a first device and the second media asset is displayed on a second device.

8. The method of claim 1, wherein the first media asset is a broadcast media asset and the second media asset is an on-demand media asset.

9. The method of claim 1, further comprises determining the second schedule based on at least in part on a user profile.

10. The method of claim 1, further comprises determining the second schedule based on at least in part on a second play length of the second media asset.

11. The method of claim 1, further comprises determining the second schedule based on at least in part a user input.

12. The method of claim 6, wherein the quality associated with the advertisements displayed during the portion of the first play length depends on a type of the first media asset.

13. A system for transmitting advertisements associated with media assets, the system comprising:
a processor configured to:
transmitting a first media asset to user equipment, said first media asset having a first play length;
determine a first advertisement schedule for a plurality of advertisements to be displayed during the first play length of the first media asset;
receiving a user input requesting access of a second media asset during the first play length;
transmitting the second media asset to user equipment after a portion of the first play length;
determining a second advertisement schedule for the second media asset, wherein the second advertisement schedule is based at least in part on a number of advertisements of the first advertisement schedule displayed during the portion of the first play length.

14. The system of claim 13, wherein the processor is further configured to determine a default advertisement schedule for the second media asset, wherein the second advertisement schedule is further based at least in part on the default advertisement schedule for the second media asset.

15. The system of claim 13, wherein the second advertisement schedule comprises a number of advertisement intervals.

16. The system of claim 15, wherein the number of advertisement intervals and each advertisement interval's location in the second media asset is based at least in part on the number of advertisements displayed during the portion of the first play length.

17. The system of claim 13, wherein the processor is further configured to determine an allocation of advertisements associated with the portion of the first play length, wherein the number of advertisements in the second schedule is based at least in part on the allocation.

18. The system of claim 13, wherein the number of advertisements in the second schedule further depends on a quality associated with the advertisements displayed during the portion of the first play length.

19. The system of claim 13, wherein the first media asset is displayed on a first device and the second media asset is displayed on a second device.

20. The system of claim 13, wherein the first media asset is a broadcast media asset and the second media asset is an on-demand media asset.

21. The system of claim 13, wherein the processor is further configured to determine the second schedule based on at least in part on a user profile.

22. The system of claim 13, wherein the processor is further configured to determine the second schedule based on at least in part on a second play length of the second media asset.

23. The system of claim 13, wherein the processor is further configured to determine the second schedule based on at least in part a user input.

24. The system of claim 18, wherein the quality associated with the advertisements displayed during the portion of the first play length depends on a type of the first media asset.

25-36. (canceled)
